(19) United States
(12) Patent Application Publication
(10) Pub. No.: US 2026/0311916 A1
(43) Pub. Date: Oct. 8, 2026

(54) RARE EARTH SINTERED MAGNET, METHOD FOR PRODUCING RARE EARTH SINTERED MAGNET, ROTOR, AND ROTARY MACHINE

(71) Applicant: Mitsubishi Electric Corporation, Tokyo (JP)

(72) Inventors: Akito IWASAKI, Tokyo (JP); Yasutaka NAKAMURA, Tokyo (JP)

(73) Assignee: Mitsubishi Electric Corporation, Tokyo (JP)

(21) Appl. No.: 19/484,005

(22) PCT Filed: Jul. 4, 2023
(86) PCT No.: PCT/JP2023/024736

§ 371 Date: Nov. 13, 2025

(51) Int. Cl. H01F 1/055; B22F 3/16; B22F 3/24; B22F 9/04; C22C 33/04; C22C 38/00; H02K 1/02; H02K 1/2706

(52) U.S. Cl. CPC H01F 1/055; B22F 3/16; B22F 3/24; B22F 9/04; C22C 33/04; C22C 38/002; C22C 38/005; H02K 1/02; H02K 1/2706; B22F 2003/248; B22F 2301/355; B22F 2998/10; B22F 2999/00; C22C 2202/02

(57) ABSTRACT

A rare earth sintered magnet (1) includes a main phase (10) that satisfies a general formula (Nd, Pr, RH, R)—Fe—B, where RH is a heavy rare earth element including at least one of Dy or Tb, R is one or more rare earth elements selected excluding Nd, Pr, Dy, and Tb, the main phase containing crystal grains based on an Nd₂Fe₁₄B crystal structure. The main phase includes a core portion (11c, 12c) and a shell portion (11s, 12s) covering the core portion. The main phase includes a first main phase (11) that satisfies CNd>CPr and a second main phase (12) that satisfies CNd<CPr, where CNd is concentration of Nd in the core portion and CPr is concentration of Pr in the core portion. The concentration of the heavy rare earth element RH in the core portion (11c) of the first main phase is higher than the concentration of the heavy rare earth element RH in the core portion (12c) of the second main phase. The first main phase and the second main phase are provided mixedly.

### FIELD

The present disclosure relates to a rare earth sintered magnet which is a permanent magnet obtained by sintering a material containing a rare earth element, a method for producing a rare earth sintered magnet, a rotor, and a rotary machine.

### BACKGROUND

R-T-B-based permanent magnets having a tetragonal R₂T₁₄B intermetallic compound as a main phase are known. Here, R is a rare earth element, T is a transition metal element such as Fe (iron) or Fe that is partially replaced by cobalt (Co), and B is boron. R-T-B-based permanent magnets are used for various components having a high added value, including for example industrial motors. In particular, Nd—Fe—B-based sintered magnets in which R is neodymium (Nd) are used for various components due to excellent magnetic properties. In addition, because industrial motors are often used in a high temperature environment exceeding 100° C., attempts have been made to improve coercive force by adding heavy rare earth elements such as dysprosium (Dy) to Nd-T-B-based sintered magnets.

In recent years, the production of Nd—Fe—B-based sintered magnets has been expanded, and the consumption of Nd and heavy rare earth elements such as Dy and terbium (Tb) has been increased. However, Nd and heavy rare earth elements are expensive and also have a procurement risk due to high distribution unevenness. For this reason, techniques for reducing consumption of Nd and heavy rare earth elements have been studied.

Patent Literature 1 discloses an R-T-B-based sintered magnet containing main phase grains consisting of an R₂T₁₄B crystal, where R is one or more rare earth elements including a heavy rare earth element RH as an essential element, T is one or more transition metal elements including Fe or including Fe and Co as an essential element, B is boron. A part of the main phase grains of the R-T-B-based sintered magnet includes therein a plurality of low heavy rare earth element crystal phases and a plurality of nonmagnetic R-rich phases. Here, the low heavy rare earth element crystal phases are phases consisting of an R₂T₁₄B crystal and in which the concentration of the heavy rare earth element is relatively lower than the concentration of the heavy rare earth element in the entire main phase grains. The nonmagnetic R-rich phases are phases in which the content of R is 70 to 100 at. %. In addition, a part of the main phase grains has one kind of core-shell structure having a core portion and a shell portion surrounding the periphery of the core portion and having a total heavy rare earth element concentration lower than that of the core portion. According to the technique described in Patent Literature 1, it is possible to obtain an R-T-B-based sintered magnet having improved coercive force at low cost.

Patent Literature 2 discloses a method for producing a rare earth magnet consisting of: a first step of producing a sintered body represented by a composition formula of (R1₁₋ₓR2ₓ)ₐTM_{b}B_{c}M_{d} and having a structure consisting of a main phase and a grain boundary phase; a second step of producing a rare earth magnet precursor by subjecting the sintered body to hot plastic working; and a third step of producing a rare earth magnet by causing a melt of an R3-M modified alloy to be diffused and permeating through the grain boundary phase of the rare earth magnet precursor. Here, R1 is one or more rare earth elements including Y (yttrium), R2 is a rare earth element different from R1, TM is a transition metal including one or more of Fe, nickel (Ni), and Co, B is boron, and M is one or more of titanium (Ti), gallium (Ga), zinc (Zn), silicon (Si), aluminum (Al), niobium (Nb), zirconium (Zr), Ni, Co, manganese (Mn), vanadium (V), tungsten (W), tantalum (Ta), germanium (Ge), copper (Cu), chromium (Cr), hafnium (Hf), molybdenum (Mo), phosphorus (P), carbon (C), magnesium (Mg), mercury (Hg), silver (Ag), and gold (Au). Further, x, a, b, c, and d satisfy 0.01≤x≤1, 12≤a≤20, b=100−a−c−d, 5≤c≤20, and 0≤d≤3, all by at. %. R3 is a rare earth element including R1 and R2. Hereinafter, hot plastic working applied to a sintered body is referred to as hot working. According to the technique described in Patent Literature 2, it is possible to reduce the heavy rare earth element, and produce a rare earth magnet excellent in not only magnetization but also coercive force performance even when the main phase ratio is high.

### CITATION LIST

### Patent Literature

Patent Literature 1: Japanese Patent Application Laid-open No. 2018-174313 (JP 2018-174313 A)
Patent Literature 2: Japanese Patent Application Laid-open No. 2015-153813 (JP 2015-153813 A)

### SUMMARY OF INVENTION

### Problem to be Solved by the Invention

However, in the R-T-B-based sintered magnet described in Patent Literature 1, a phase including a heavy rare earth element is present in the main phase, which improves coercive force. However, the structure of the R-T-B-based sintered magnet cannot yield the residual magnetic flux density required for industrial motors or the like, which may lead to degradation of magnetic properties due to thermal load. Even though the rare earth magnet produced with the production method described in Patent Literature 2 can reduce heavy rare earth elements and improve the coercive force, the production method includes hot working, which reduces the particle size of the main phase and results in the problem of deterioration of magnetizing ability.

The present disclosure has been made in view of the above, and an object thereof is to obtain a rare earth sintered magnet capable of improving the coercive force without lowering the residual magnetic flux density and the magnetizing ability as compared with the related art.

### Means to Solve the Problem

In order to solve the above-described problems and achieve the object, a rare earth sintered magnet according to the present disclosure includes a main phase that satisfies a general formula (Nd, Pr, RH, R)—Fe—B, where RH is a heavy rare earth element including at least one of Dy or Tb, R is one or more rare earth elements selected excluding Nd, Pr (praseodymium), Dy, and Tb, the main phase containing crystal grains based on an Nd₂Fe₁₄B crystal structure. The main phase includes a core portion and a shell portion covering the core portion. The main phase includes a first main phase that satisfies CNd>CPr and a second main phase that satisfies CNd<CPr, where CNd is concentration of Nd in the core portion and CPr is concentration of Pr in the core portion. The concentration of the heavy rare earth element RH in the core portion of the first main phase is higher than the concentration of the heavy rare earth element RH in the core portion of the second main phase. The first main phase and the second main phase are provided mixedly.

### Effects of the Invention

The rare earth sintered magnet according to the present disclosure can achieve the effect of improving the coercive force without lowering the residual magnetic flux density and the magnetizing ability as compared with the related art.

### BRIEF DESCRIPTION OF DRAWINGS

FIG. 1 is a diagram schematically illustrating an exemplary sintered structure of a rare earth sintered magnet according to a first embodiment.

FIG. 2 is a diagram schematically illustrating an exemplary sintered structure of a rare earth sintered magnet according to the second embodiment.

FIG. 3 is a diagram illustrating atomic sites in a tetragonal Nd₂Fe₁₄B crystal structure.

FIG. 4 is a flowchart illustrating an exemplary procedure of a method for producing a rare earth sintered magnet alloy according to the third embodiment.

FIG. 5 is a flowchart illustrating an exemplary procedure of a method for producing a rare earth sintered magnet according to the third embodiment.

FIG. 6 is a cross-sectional view schematically illustrating an exemplary configuration of a rotor equipped with a rare earth sintered magnet according to the fourth embodiment.

FIG. 7 is a cross-sectional view schematically illustrating an exemplary configuration of a rotary machine according to the fifth embodiment.

FIG. 8 is a trace of a composition image obtained by analyzing a cross section of a rare earth sintered magnet according to Examples 1 to 8 with FE-EPMA.

FIG. 9 is an element map of Nd obtained by analyzing a cross section of a rare earth sintered magnet according to Examples 1 to 8 with FE-EPMA.

FIG. 10 is an element map of Pr obtained by analyzing a cross section of a rare earth sintered magnet according to Examples 1 to 8 with FE-EPMA.

FIG. 11 is an element map of Tb obtained by analyzing a cross section of a rare earth sintered magnet according to Examples 1 to 8 with FE-EPMA.

FIG. 12 is an element map of oxygen (O) obtained by analyzing a cross section of a rare earth sintered magnet according to Examples 1 to 8 with FE-EPMA.

FIG. 13 is an element map of samarium (Sm) obtained by analyzing a cross section of a rare earth sintered magnet according to Examples 1 to 8 with FE-EPMA.

FIG. 14 is an element map of lanthanum (La) obtained by analyzing a cross section of a rare earth sintered magnet according to Examples 1 to 8 with FE-EPMA.

### DESCRIPTION OF EMBODIMENTS

Hereinafter, a rare earth sintered magnet, a method for producing a rare earth sintered magnet, a rotor, and a rotary machine according to embodiments of the present disclosure will be described in detail with reference to the drawings.

### First Embodiment

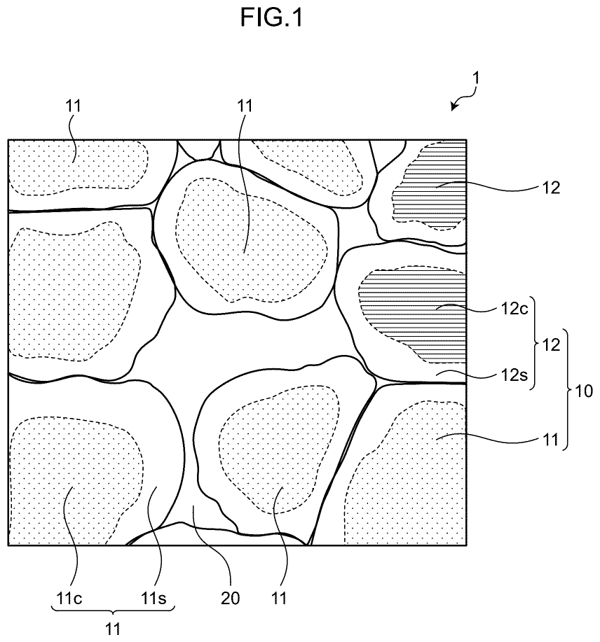

FIG. 1 is a diagram schematically illustrating an exemplary sintered structure of a rare earth sintered magnet according to the first embodiment. The rare earth sintered magnet 1 according to the first embodiment includes a main phase 10 that satisfies a general formula (Nd, Pr, RH, R)—Fe—B and contains crystal grains based on an Nd₂Fe₁₄B crystal structure, and the main phase 10 includes a core portion and a shell portion covering the core portion. Here, RH is a heavy rare earth element, and is, for example, Dy, Tb, Gd (gadolinium), or Ho (holmium), and preferably a heavy rare earth element including at least one of Dy or Tb. R is one or more rare earth elements selected excluding Nd, Pr, and RH. The shell portion has a composition different from that of the core portion and is provided so as to cover the core portion. The rare earth sintered magnet 1 further includes a subphase 20 existing between the main phase 10 and the main phase 10. The subphase 20 will be described in the second embodiment.

In the rare earth sintered magnet 1 according to the first embodiment, the main phase 10 includes a first main phase 11 that satisfies CNd>CPr and a second main phase 12 that satisfies CNd<CPr, where CNd is the concentration of Nd in core portions 11c and 12c and CPr is the concentration of Pr in the core portions 11c and 12c, and the first main phase 11 and the second main phase 12 are provided mixedly. The concentration of the heavy rare earth element RH in the core portion 11c of the first main phase 11 is higher than the concentration of the heavy rare earth element RH in the core portion 12c of the second main phase 12. That is, given that the concentration of the heavy rare earth element RH in the core portion 11c of the first main phase 11 is C1RH and the concentration of the heavy rare earth element RH in the core portion 12c of the second main phase 12 is C2RH, C1RH>C2RH is satisfied. The first main phase 11 includes the core portion 11c and a shell portion 11s having a composition different from that of the core portion 11c and covering the core portion 11c. The second main phase 12 includes the core portion 12c and a shell portion 12s having a composition different from that of the core portion 12c and covering the core portion 12c.

Alternatively, in the rare earth sintered magnet 1 according to the first embodiment, it can be said that the main phase 10 includes a first main phase 11 that satisfies C(Nd,RH)>CPr and a second main phase 12 that satisfies C(Nd,RH)<CPr, where C(Nd,RH) is the sum of the concentration of Nd and the concentration of the heavy rare earth element RH in core portions 11c and 12c, and the first main phase 11 and the second main phase 12 are provided mixedly.

This means that the rare earth sintered magnet 1 has two types of main phases 10, i.e., the first main phase 11 and the second main phase 12, and focusing on the core portions 11c and 12c of the two types of main phases 10, the sum of the concentration of Nd and the concentration of the heavy rare earth element RH is higher than the concentration of Pr in the first main phase 11, and conversely, the concentration of Pr is higher than the sum of the concentration of Nd and the concentration of the heavy rare earth element RH in the second main phase 12. As described above, by mixing two types of main phases 10 having core-shell structures that differ in anisotropic magnetic field, that is, magnetic anisotropy, and causing the heavy rare earth element RH to selectively exist in the main phase 10, it is possible to reduce Nd and the heavy rare earth element RH and also improve the residual magnetic flux density and the coercive force while maintaining good magnetization. Furthermore, the coercive force is greatly improved by adding the heavy rare earth element RH, which also contributes to preventing degradation of magnetic properties due to a temperature change.

Here, the concentration difference indicated by “C1RH>C2RH” means that there is a clear difference in the detection intensity of the heavy rare earth element RH in the core portion 11c of the first main phase 11 and the core portion 12c of the second main phase 12 by mapping analysis using an electron probe microanalyzer (EPMA). Specifically, the EPMA detection intensity of the concentration of the heavy rare earth element RH in the core portion 11c of the first main phase 11 is higher than the average of the detection intensity of the heavy rare earth element RH, and the EPMA detection intensity of the concentration of the heavy rare earth element RH in the core portion 12c of the second main phase 12 indicates around the lower limit of the detection intensity of the heavy rare earth element RH. In one example, the heavy rare earth element RH is included in the core portion 11c of the first main phase 11, but is hardly included in the core portion 12c of the second main phase 12.

In addition, the concentration difference indicated by “the first main phase 11 that satisfies C(Nd,RH)>CPr and the second main phase 12 that satisfies C(Nd,RH)<CPr” means that there is a clear difference between the detection intensity of Nd and the heavy rare earth element RH and the detection intensity of Pr. Specifically, taking the case of the first main phase 11 as an example, the EPMA detection intensity of the concentration of Nd and the heavy rare earth element RH in the core portion 11c is higher than the average of the detection intensity of Nd and the heavy rare earth element RH, and the EPMA detection intensity of the concentration of Pr indicates around the lower limit of the detection intensity of Pr. The case in the second main phase 12 is the reverse of the case in the first main phase 11.

The rare earth sintered magnet 1 according to the first embodiment satisfies relational expressions of C1Nd>C2Nd and C1Pr<C2Pr, where C1Nd is the Nd concentration of the core portion 11c of the first main phase 11, C2Nd is the Nd concentration of the core portion 12c of the second main phase 12, C1Pr is the Pr concentration of the core portion 11c of the first main phase 11, and C2Pr is the Pr concentration of the core portion 12c of the second main phase 12. That is, the Nd concentration is higher in the core portion 11c of the first main phase 11 than in the core portion 12c of the second main phase 12, and conversely, the Pr concentration is higher in the core portion 12c of the second main phase 12 than in the core portion 11c of the first main phase 11. The concentration difference here also means that there is a difference in the detection intensity of Nd and Pr by the mapping analysis using the EPMA. Specifically, in the case of the concentration of Nd, it means that the EPMA detection intensity of Nd in the core portion 11c of the first main phase 11 is higher than the average of the detection intensity of Nd, and the EPMA detection intensity of Nd in the core portion 12c of the second main phase 12 is lower than the average of the detection intensity of Nd. In the case of the concentration of Pr, it means that the EPMA detection intensity of Pr in the core portion 12c of the second main phase 12 is higher than the average of the detection intensity of Pr, and the EPMA detection intensity of Pr in the core portion 11c of the first main phase 11 is lower than the average of the detection intensity of Pr. That is, a large amount of Pr exists in the core portion 12c of the second main phase 12 having a low Nd concentration, and conversely, a large amount of Nd exists in the core portion 11c of the first main phase 11 having a low Pr concentration. Control to achieve such a structure form results in obtaining the rare earth sintered magnet 1 having excellent magnetic properties.

In the rare earth sintered magnet 1 according to the first embodiment, the first main phases 11 each of which satisfies C(Nd,RH)>CPr are present more than the second main phases 12 each of which satisfies C(Nd,RH)<CPr. In other words, it means that the number of first main phases 11 having the composition formula of (Nd,RH)₂Fe₁₄B is larger than the number of the second main phases 12 having the composition formula of Pr₂Fe₁₄B. This is because increasing the first main phase 11 having the composition formula of (Nd,RH)₂Fe₁₄B results in more excellent magnetic properties and temperature properties than increasing the second main phase 12 having the composition formula of Pr₂Fe₁₄B. Furthermore, control to achieve such a structure form also prevents refinement of the crystal grains as a whole, so that it is possible to obtain excellent magnetic properties as compared with the related art while securing magnetization.

In the rare earth sintered magnet 1 according to the first embodiment, focusing on the shell portions 11s and 12s of the core-shell structures, the first main phase 11 satisfies the relational expressions of CNd>SNd, CPr<SPr, and CRH>SRH, and the second main phase 12 satisfies the relational expressions of CNd<SNd, CPr>SPr, and CRH<SRH, where SNd is the concentration of Nd in the shell portions 11s and 12s, SPr is the concentration of Pr in the shell portions 11s and 12s, and SRH is the concentration of the heavy rare earth element RH in the shell portions 11s and 12s. Specifically, in the shell portion 11s of the first main phase 11, the concentration of Nd and the heavy rare earth element RH is lower than that in the core portion 11c, but the concentration of Pr is higher than that in the core portion 11c. In the shell portion 12s of the second main phase 12, the concentration of Pr is lower than that in the core portion 12c, but the concentration of Nd and the heavy rare earth element RH is higher than that in the core portion 12c.

In other words, in the rare earth sintered magnet 1 according to the first embodiment, focusing on the shell portions 11s and 12s of the core-shell structures, the first main phase 11 satisfies the relational expressions of C(Nd,RH)>S(Nd,RH) and CPr<SPr, and the second main phase 12 satisfies the relational expressions of C(Nd,RH)<S(Nd,RH) and CPr>SPr, where S(Nd,RH) is the sum of the concentration of Nd and the concentration of the heavy rare earth element RH in the shell portions 11s and 12s, and SPr is the concentration of Pr in the shell portions 11s and 12s. Specifically, in the shell portion 11s of the first main phase 11, the sum of the concentration of Nd and the concentration of the heavy rare earth element RH is lower than that in the core portion 11c, but the concentration of Pr is higher than that in the core portion 11c. In the shell portion 12s of the second main phase 12, the concentration of Pr is lower than that in the core portion 12c, but the sum of the concentration of Nd and the concentration of the heavy rare earth element RH is higher than that in the core portion 12c.

By forming the main phase 10 including the shell portion 11s having a high concentration of Pr like the first main phase 11, the coercive force can be improved. Furthermore, by forming the main phase 10 including the shell portion 12s having a high sum of the concentration of Nd and the heavy rare earth element RH like the second main phase 12, it is possible to prevent degradation of the residual magnetic flux density while maintaining the coercive force. Through selective control to achieve such a structure form, the rare earth sintered magnet 1 can exhibit excellent magnetic properties as compared with the related art.

Further, the average grain size of the crystal grains of the main phase 10 is preferably 100 μm or less, and more preferably 0.5 μm to 50 μm for improving magnetic properties. Furthermore, setting the average grain size to about 1 μm to 10 μm results in a grain size different from the microstructure produced by hot working, leading to the rare earth sintered magnet 1 that maintains good magnetizing ability and has excellent magnetic properties as compared with the related art.

The rare earth sintered magnet 1 according to the first embodiment may contain an additive element M that further improves magnetic properties. The additive element M is one or more elements selected from the group consisting of Ga, Cu, Al, Co, Zr, Ti, Nb, and Mn. Therefore, in the rare earth sintered magnet 1 according to the first embodiment, the general formula is expressed by (NdₐPr_{b}R_{c}RH_{d})FeₑB_{f}M_{g}, where RH is a heavy rare earth element which is one or more elements selected from the group consisting of Dy, Tb, Gd, and Ho, and R is a rare earth element other than Nd, Pr, and the heavy rare earth element RH. It is desirable that a, b, c, d, e, f, and g satisfy the following relational expressions.

$$\begin{matrix}5 \leq a + b \leq 20 \\ 0 < c + d < ( a + b ) \\ 0 < d < 10 \\ 70 \leq e \leq 90 \\ 0.5 \leq f \leq 10 \\ 0 \leq g \leq 5 \\ a + b + c + d + e + f + g = 100 at . \%\end{matrix}$$

The rare earth sintered magnet 1 according to the first embodiment includes the main phase 10 that satisfies a general formula (Nd, Pr, RH, R)—Fe—B, where R is one or more rare earth elements selected excluding Nd, Pr, and the heavy rare earth element RH, the main phase 10 containing crystal grains based on an Nd₂Fe₁₄B crystal structure, wherein the main phase 10 includes the core portions 11c and 12c and the shell portions 11s and 12s covering the core portions 11c and 12c, the main phase 10 includes the first main phase 11 that satisfies CNd>CPr and the second main phase 12 that satisfies CNd<CPr, the concentration of the heavy rare earth element RH in the first main phase 11 is higher than the concentration of the heavy rare earth element RH in the second main phase 12, and the first main phase 11 and the second main phase 12 are provided mixedly. With such a configuration, it is possible to obtain the rare earth sintered magnet 1 in which magnetic properties and magnetization are improved as compared with the related art, while reducing use of Nd and the heavy rare earth element RH.

Now we compare the R-T-B-based sintered magnet described in Patent Literature 1 with the rare earth sintered magnet 1 according to the first embodiment. The R-T-B-based sintered magnet described in Patent Literature 1 has one or more rare earth elements essentially including the heavy rare earth element RH, and has one kind of main phase grain composed of a core portion and a shell portion. That is, in Patent Literature 1, the heavy rare earth element RH is contained in all the main phase grains in the R-T-B-based sintered magnet. On the other hand, in the rare earth sintered magnet 1 according to the first embodiment, the main phase 10 includes the first main phase 11 and the second main phase 12, and the concentration of the heavy rare earth element RH is lower in the second main phase 12 than in the first main phase 11. In one example, the core portion 11c of the first main phase 11 contains the heavy rare earth element RH, but the core portion 12c of the second main phase 12 hardly contains the heavy rare earth element RH. That is, the heavy rare earth elements RH are selectively disposed in the main phase 10. As described above, compared with the R-T-B-based sintered magnet described in Patent Literature 1 in which the heavy rare earth element RH must be contained in all the main phases of only one kind, the rare earth sintered magnet 1 according to the first embodiment including the main phase 10 having the first main phase 11 and the second main phase 12 having a lower concentration of the heavy rare earth element RH than the first main phase 11 can reduce the amount of the heavy rare earth element RH used. In particular, in a case where the heavy rare earth element RH is hardly contained in the second main phase 12, the heavy rare earth element RH is selectively disposed, and the amount of the heavy rare earth element RH used can be reduced as compared with the R-T-B-based sintered magnet described in Patent Literature 1.

Now we compare the rare earth magnet produced with the technique described in Patent Literature 2 with the rare earth sintered magnet 1 according to the first embodiment. In order to obtain magnetic properties equivalent to those of the rare earth sintered magnet 1 according to the first embodiment with the rare earth magnet produced with the technique described in Patent Literature 2, as shown in Examples described later, more heavy rare earth elements RH have to be added as compared with the rare earth sintered magnet 1 according to the first embodiment. That is, the rare earth sintered magnet 1 according to the first embodiment can reduce the amount of the heavy rare earth element RH used as compared with the technique described in Patent Literature 2 when trying to obtain the same magnetic properties. Alternatively, in a case where the content of the heavy rare earth element RH in the rare earth magnet produced with the technique described in Patent Literature 2 is the same as the content of the heavy rare earth element RH in the rare earth sintered magnet 1 according to the first and second embodiments, the magnetic properties of the rare earth magnet produced with the technique described in Patent Literature 2 are lower than the magnetic properties of the rare earth sintered magnet 1 according to the first and second embodiments.

In the rare earth sintered magnet 1 according to the first embodiment, the first main phase 11 and the second main phase 12 satisfy the relational expressions of C1Nd>C2Nd and C1Pr<C2Pr. Alternatively, the number of first main phases 11 is larger than the number of second main phases 12. Alternatively, the first main phase 11 satisfies the relational expressions of CNd>SNd, CPr<SPr, and CRH>SRH, and the second main phase 12 satisfies the relational expressions of CNd<SNd, CPr>SPr, and CRH<SRH. This also makes it possible to obtain the rare earth sintered magnet 1 in which magnetic properties and magnetization are improved, while reducing use of Nd and the heavy rare earth element RH.

Furthermore, since the main phase 10 contains the heavy rare earth element RH, the rare earth sintered magnet 1 in which the coercive force is greatly improved as compared with the related art is obtained. In addition, as shown in Examples to be described later, the rare earth sintered magnet 1 having a better coercive force temperature coefficient than the related art can be obtained. For this reason, even when a thermal load is applied to the rare earth sintered magnet 1, the coercive force is larger than that in the related art, and the decrease of the coercive force due to the temperature rise is also more moderate than that in the related art. That is, since the coercive force is greatly improved as compared with the conventional rare earth sintered magnet, the magnetic properties when a thermal load is applied to the rare earth sintered magnet 1 are also better than those of the conventional rare earth sintered magnet.

### Second Embodiment

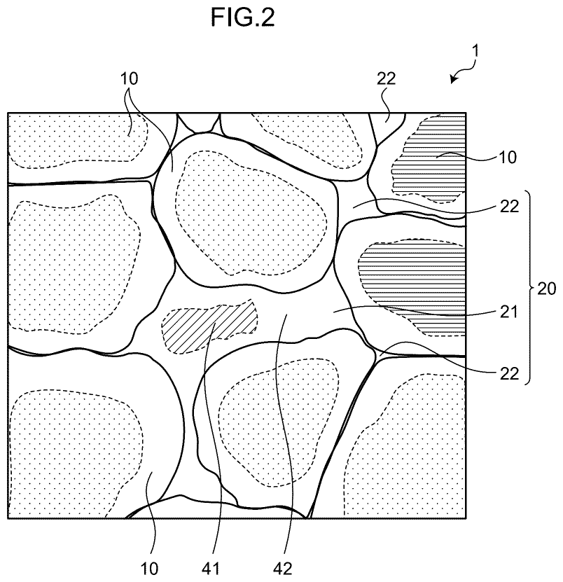

FIG. 2 is a diagram schematically illustrating an exemplary sintered structure of a rare earth sintered magnet according to the second embodiment. The rare earth sintered magnet 1 according to the second embodiment includes the main phase 10 and the subphase 20. The main phase 10 includes the first main phase 11 and the second main phase 12 as described in the first embodiment, but in FIG. 2, the first main phase 11 and the second main phase 12 are collectively denoted by the main phase 10. The subphase 20 is present between the main phases 10.

In the rare earth sintered magnet 1 according to the second embodiment, a case where La and Sm are selected as the rare earth element R will be described. In a case where La and Sm are selected as the rare earth element R, the effect of improving the magnetic properties and having excellent magnetization as compared with the related art, while reducing use of Nd and the heavy rare earth element RH, is further enhanced. In this example, the main phase 10 has the composition formula (Nd, Pr, RH, La, Sm)₂Fe₁₄B. The reason why the rare earth element R of the rare earth sintered magnet 1 having a tetragonal R₂Fe₁₄B crystal structure is rare earth elements including La and Sm is that the calculation of magnetic interaction energy with the use of a molecular orbital method shows that a composition in which La and Sm are added can produce the rare earth sintered magnet 1 which is suitable for practical use in that degradation of magnetic properties associated with temperature rise can be significantly prevented. In addition, by intentionally segregating La and Sm also in the grain boundary, which is an example of the subphase 20, it is possible to cause Nd and Pr to be relatively diffused throughout the main phase 10, resulting in enhanced magnetocrystalline anisotropy of the main phase 10. As a result, a core-shell structure in which a portion having high magnetic anisotropy and a portion having low magnetic anisotropy exist in the main phase 10 is formed, and a state is easily formed in which the rare earth sintered magnet 1 in which the first main phase 11 that satisfies CNd>CPr and the second main phase 12 that satisfies CNd<CPr are provided mixedly, and the concentration of the heavy rare earth element RH in the core portion 11c of the first main phase 11 is higher than the concentration of the heavy rare earth element RH in the core portion 12c of the second main phase 12.

Note that adding too much La and Sm causes a decrease in the amount of Nd and Pr, which are elements having a high magnetic anisotropy constant and a high saturation magnetic polarization, resulting in degradation of magnetic properties. Therefore, (A+B)>(C+D) is preferably satisfied, where A, B, C, and D are the composition ratios of Nd, Pr, La, and Sm, respectively.

In the rare earth sintered magnet 1 according to the second embodiment, given R=La and/or Sm, the rare earth sintered magnet 1 includes the subphase 20 in addition to the first main phase 11 and the second main phase 12 in the first embodiment. The subphase 20 includes a crystalline first subphase 21 based on an oxide phase having a main component represented by (Nd, Pr, RH, La, Sm)—O, and a crystalline second subphase 22 having a main component represented by (Nd, Pr, RH, La)—O. O is oxygen. The concentration of Sm in the subphase 20 is higher in the first subphase 21 than in the second subphase 22. That is, the first subphase 21 forms an Sm enrichment portion 41 having a higher Sm concentration than the second subphase 22. This achieves the effect of preventing not only degradation of the magnetic properties at room temperature but also degradation of the magnetic properties associated with temperature rise.

Here, “the concentration of Sm is higher in the first subphase 21 than in the second subphase 22” means that the detection intensity of Sm is higher on average in the first subphase 21 than in the second subphase 22 by mapping analysis using EPMA.

The crystalline subphase 20 is a generic name for the crystalline first subphase 21 and the crystalline second subphase 22, and is present between the main phases 10. The crystalline first subphase 21 is represented by (Nd, Pr, RH, La, Sm)—O, and the crystalline second subphase 22 is represented by (Nd, Pr, RH, La)—O. Here, (Nd, Pr, RH, La, Sm) means that a part of Nd and Pr is replaced by the heavy rare earth element RH, La, and Sm. Note that the elements of the main components are described in parentheses; therefore, the first subphase 21 and the second subphase 22 may contain a small amount of another component, in addition to the elements indicated in parentheses. In one example, the second subphase 22 represented by (Nd, Pr, RH, La)—O contains an extremely small amount of Sm.

In the rare earth sintered magnet 1 according to the second embodiment, there is a concentration difference of La and Sm between the main phase 10 and the subphase 20, and La and Sm are segregated in the subphase 20 more than in the main phase 10. That is, the sum of the concentrations of La in the first subphase 21 and the second subphase 22 is equal to or greater than the concentration of La in the main phase 10, and the sum of the concentrations of Sm in the first subphase 21 and the second subphase 22 is equal to or greater than the concentration of Sm in the main phase 10. Specifically, the concentrations of La and Sm in the subphase 20 are equal to or higher than the concentrations of La and Sm in the main phase 10. Here, the concentration of La of the main phase 10 is the sum of the concentration of La of the first main phase 11 and the concentration of La of the second main phase 12. That is, the sum of the concentrations of La in the first subphase 21 and the second subphase 22 is higher than the sum of the concentrations of La in the first main phase 11 and the second main phase 12. Here, the concentration of Sm of the main phase 10 is the sum of the concentration of Sm of the first main phase 11 and the concentration of Sm of the second main phase 12. That is, the sum of the concentrations of Sm in the first subphase 21 and the second subphase 22 is higher than the sum of the concentrations of Sm in the first main phase 11 and the second main phase 12.

Here, given that X represents the concentration of La contained in the main phase 10, X₁ represents the concentration of La contained in the first subphase 21, X₂ represents the concentration of La contained in the second subphase 22, Y represents the concentration of Sm contained in the main phase 10, Y₁ represents the concentration of Sm contained in the first subphase 21, and Y₂ represents the concentration of Sm contained in the second subphase 22, the relationship of Formula (1) below is satisfied.

$$1 < ( {Y}_{1} + {Y}_{2} ) / Y < ( {X}_{1} + {X}_{2} ) / X \qquad ( 1 )$$

Furthermore, from the viewpoint of improving the magnetic properties, the relationships of Formulas (2) and (3) below are satisfied with respect to the concentrations of Nd and Pr contained in the main phase 10.

$$( CNd + SNd ) > ( X + Y ) \qquad ( 2 )$$

$$( CPr + SPr ) > ( X + Y ) \qquad ( 3 )$$

In the above description, the concentration of La in the main phase 10 is the sum of the concentrations of La in the first main phase 11 and the second main phase 12, and the concentration of Sm in the main phase 10 is the sum of the concentrations of Sm in the first main phase 11 and the second main phase 12. This indicates that both La and Sm are segregated in the subphase 20 more than in the main phase 10. However, when viewed locally, each of the sum of the concentrations of La and Sm in the first main phase 11 and the second main phase 12 and each of the sum of the concentrations of La and Sm in the first subphase 21 and the second subphase 22 may not satisfy the above relationship. Therefore, more specifically, the concentration of La in the main phase 10 indicates the average of the concentrations of La in the first main phase 11 and the second main phase 12, and the concentration of Sm in the main phase 10 indicates the average of the concentrations of Sm in the first main phase 11 and the second main phase 12. In this case, the concentration of La of the subphase 20, that is, the sum of the concentrations of La in the first subphase 21 and the second subphase 22 means the average of the concentrations of La in the first subphase 21 and the second subphase 22, and the concentration of Sm of the subphase 20, that is, the sum of the concentrations of Sm in the first subphase 21 and the second subphase 22 means the average of the concentrations of Sm in the first subphase 21 and the second subphase 22.

La is present at a high concentration in the grain boundary in the process of production, particularly in the heat treatment, whereby Nd and Pr are relatively diffused throughout the main phase 10. As a result, in the rare earth sintered magnet 1 according to the second embodiment, Nd and Pr in the main phase 10 are not consumed at the grain boundary, leading to improved magnetocrystalline anisotropy. Sm is also present at a higher concentration in the subphase 20, particularly in the first subphase 21, than in the main phase 10, whereby Nd is relatively diffused throughout the main phase 10 as in the case of La, resulting in improved magnetocrystalline anisotropy.

As described in the above, since the subphase 20 contains the heavy rare earth element RH, the first subphase 21 and the second subphase 22 contain the heavy rare earth element RH, the distribution of the heavy rare earth element RH is different between the first subphase 21 and the second subphase 22. In the second subphase 22 having a lower Sm concentration than the first subphase 21, the heavy rare earth element RH is uniformly distributed in the second subphase 22. On the other hand, in the first subphase 21 forming the Sm enrichment portion 41, the heavy rare earth element RH is not uniformly distributed in the first subphase 21, but is selectively distributed between the outer contour of the first subphase 21 and the Sm enrichment portion 41, that is, in the inner peripheral portion of the outer contour of the first subphase 21. Specifically, the heavy rare earth element RH exists so as to selectively surround the outer contour of the Sm enrichment portion 41 of the first subphase 21 having a high Sm concentration. From this, it can be said that the first subphase 21 has the Sm enrichment portion 41 and a heavy rare earth element containing portion 42 in which the heavy rare earth element RH selectively surrounding the outer contour of the Sm enrichment portion 41 exists. The outer contour of the first subphase 21 is a boundary portion between the first subphase 21 and the main phase 10.

In this manner, the first subphase 21 and the second subphase 22 having the heavy rare earth element RH are present between the main phase 10 and the main phase 10. Therefore, it can be considered that the heavy rare earth element RH enters a part of the surface of the main phase 10 in contact with the first subphase 21 and the second subphase 22 having the heavy rare earth element RH. That is, similarly to the first embodiment, it is possible to prevent a decrease in residual magnetic flux density while improving the coercive force of the rare earth sintered magnet 1 also in the second embodiment.

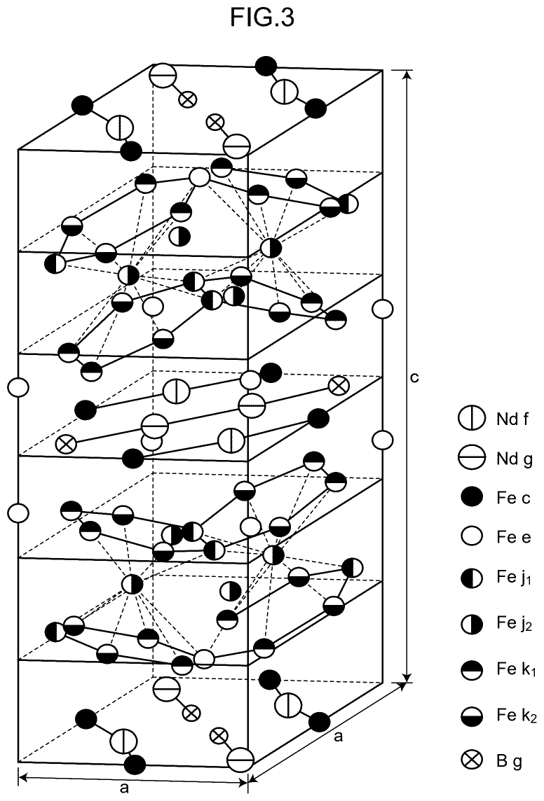

Next, at which atomic sites of the tetragonal R₂Fe₁₄B crystal structure La and Sm are substituted will be described. FIG. 3 is a diagram illustrating atomic sites in a tetragonal Nd₂Fe₁₄B crystal structure. Note that the crystal structure illustrated in FIG. 3 is described, in one example, in FIG. 1 of Reference Literature 1 shown below. The sites of substitution are determined from the numerical value of the stabilization energy associated with substitution computed using band calculation and molecular field approximation based on the Heisenberg model. (Reference Literature 1): J. F. Herbst et al., “Relationships between crystal structure and magnetic properties in Nd₂Fe₁₄B”, PHYSICAL REVIEW B. 1984, Vol. 29, No. 7, p. 4176-4178.

First, a method for calculating stabilization energy in La will be described. The stabilization energy in La can be computed as the energy difference between (Nd₇La₁)Fe₅₆B₄+Nd and Nd₈(Fe₅₅La₁)B₄+Fe using Nd: Fe₅₆B₄ crystal cells. The smaller the energy value, the more stable it is when the atom is substituted at that site. That is, La is likely to be substituted at an atomic site having the smallest energy among the atomic sites. This calculation assumes that substituting La for the original atom does not change the lattice constant in the tetragonal R₂Fe₁₄B crystal structure due to the difference in atomic radius, Table 1 shows the stabilization energy of La at each substitution site at various environmental temperatures.

TABLE 1

| SUBSTI- | | | | | | |
|---|---|---|---|---|---|---|
| TUTION | | | | | | |
| SITE | TEMPERATURE | | | | | |
| FOR La | 293K | 500K | 1000K | 1300K | 1400K | 1500K |
| Nd(f) | −136.372 | −84.943 | −48.524 | −40.132 | −38.132 | −35.451 |
| Nd(g) | −132.613 | −82.740 | −47.442 | −38.211 | −36.358 | −34.753 |
| Fe(k1) | −135.939 | −80.596 | −41.428 | −32.390 | −30.237 | −17.095 |
| Fe(k2) | −127.480 | −75.638 | −38.948 | −30.482 | −28.466 | −26.719 |
| Fe(j1) | −124.248 | −73.076 | −38.003 | −29.754 | −27.791 | −26.089 |
| Fe(j2) | −117.148 | −71.400 | −35.923 | −28.816 | −26.917 | −25.271 |
| Fe(e) | −130.814 | −77.593 | −39.926 | −31.235 | −29.164 | −27.371 |
| Fe(c) | −148.317 | −87.850 | −45.055 | −35.179 | −32.828 | −30.789 |

UNIT: eV

Table 1 indicates that stable substitution sites for La are Nd (f) sites at temperatures of 1000K and higher, and Fe (c) sites at temperatures of 293K and 500K. As will be described later, the raw material of the rare earth sintered magnet 1 according to the second embodiment is heated and melted at a temperature of 1000K or higher and then rapidly cooled. Therefore, it is considered that the raw material of the rare earth sintered magnet 1 is maintained in a state of 1000K or higher, that is, 727° C. or higher, and more preferably about 1300K, that is, 1027° C. In this case, La is considered to be substituted at Nd (f) sites or Nd (g) sites. Here, La is considered to be preferentially substituted at energetically stable Nd (f) sites, but may be substituted at Nd (g) sites having a small energy difference among the substitution sites for La. This is why Nd (g) sites are also mentioned as a candidate for the substitution sites for La.

Furthermore, when the rare earth sintered magnet 1 is produced with the production method described later, the temperature is 1000K or higher at the time of sintering, but the Fe (c) sites described in Table 1 are held in an energetically stable temperature zone repeatedly through the primary aging step, the secondary aging step, the tertiary aging step, the quaternary aging step, and the cooling step to be described later. In other words, the substitution of La at Nd sites of the main phase 10 is maintained in an unstable energy state. That is, La is mainly substituted at Nd sites of the main phase 10 in the raw material stage of the rare earth sintered magnet 1; however, with the production method described later, by intentionally holding the rare earth sintered magnet 1 repeatedly in a temperature range in an unstable energy state for the Nd sites of the main phase 10, a certain amount of La is selectively released from the Nd sites of the main phase 10, and as a result, La is segregated in the subphase 20. As a result, the main phase 10 promotes the formation of the characteristic structure, namely the core-shell structure.

Next, a method for calculating stabilization energy in Sm will be described. The stabilization energy of Sm can be computed as the energy difference between (Nd⁷Sm₁)Fe₅₆B₄+Nd and Nd₈(Fe₅₅Sm₁)B₄+Fe. Similarly to the case of La, atomic substitution does not change the lattice constant in the tetragonal R₂Fe₁₄B crystal structure. Table 2 shows the stabilization energy of Sm at each substitution site at various environmental temperatures.

TABLE 2

| SUBSTI- | | | | | | |
|---|---|---|---|---|---|---|
| TUTION | | | | | | |
| SITE | TEMPERATURE | | | | | |
| FOR Sm | 293K | 500K | 1000K | 1300K | 1400K | 1500K |
| Nd(f) | −164.960 | −101.695 | −56.921 | −46.589 | −44.128 | −41.976 |
| Nd(g) | −168.180 | −103.583 | −57.865 | −47.315 | −44.803 | −42.626 |
| Fe(k1) | −136.797 | −81.098 | −41.679 | −32.583 | −17.350 | −16.343 |
| Fe(k2) | −127.769 | −75.808 | −38.482 | −29.603 | −28.528 | −25.696 |
| Fe(j1) | −122.726 | −73.304 | −37.783 | −28.392 | −26.525 | −24.681 |
| Fe(j2) | −124.483 | −73.883 | −38.072 | −28.483 | −26.610 | −24.985 |
| Fe(e) | 125.937 | 72.525 | 35.301 | 26.633 | 24.450 | 22.782 |
| Fe(c) | −155.804 | −94.457 | −48.359 | −37.720 | −35.187 | −32.992 |

UNIT: eV

Table 2 indicates that stable substitution sites for Sm are Nd (g) sites at any temperature, unlike in the case of La. Sm is also considered to be preferentially substituted at energetically stable Nd (g) sites, but may be substituted at Nd (f) sites having a small energy difference among the substitution sites for Sm.

When the rare earth sintered magnet 1 is produced with the production method described later, substitution at Nd (g) sites of the main phase 10 is most stable in terms of energy. However, as described above, holding in a temperature range where the substitution of La at Nd sites of the main phase 10 is unstable causes a part of Sm to be released from the Nd sites of the main phase 10 together with La and segregated in the subphase 20. As a result, the concentrations of La and Sm differ between the main phase 10 and the subphase 20: the sum of the concentrations of La in the first subphase 21 and the second subphase 22 is equal to or greater than the concentration of La in the main phase 10, and the sum of the concentrations of Sm in the first subphase 21 and the second subphase 22 is equal to or greater than the concentration of Sm in the main phase 10. More specifically, the average of the concentrations of La in the first subphase 21 and the second subphase 22 is equal to or greater than the average of the concentrations of La in the first main phase 11 and the second main phase 12, and the average of the concentrations of Sm in the first subphase 21 and the second subphase 22 is equal to or greater than the average of the concentrations of Sm in the first main phase 11 and the second main phase 12. That is, La and Sm can be said to be segregated in the subphase 20.

Comparing La and Sm, La held in a temperature range in an unstable energy state is overwhelmingly more likely to be segregated in the subphase 20 from the viewpoint of energy. As a result, in the case of the rare earth sintered magnet 1 prepared with almost the same concentrations of La and Sm, comparing La and Sm present in the rare earth sintered magnet 1, La has a larger segregation ratio to the subphase 20. By being held repeatedly in this temperature region, the subphase 20 produces a concentration difference in Sm that has a small segregation ratio, and the first subphase 21 and the second subphase 22 are formed. This promotes the formation of the core-shell structure in the main phase 10.

Here, Nd is representatively described as illustrated in FIG. 3, but Nd and Pr are produced as a mixture as represented by didymium (Di), and thus it is considered that the energy levels of Nd and Pr are close to each other. Therefore, the same applies to a case where Nd is replaced with Pr. As the two types of Nd and Pr are present, the main phase 10 having two types of core-shell structures can be formed.

As described above, the rare earth sintered magnet 1 according to the second embodiment includes the main phase 10 that satisfies a general formula (Nd, Pr, RH, R)—Fe—B, where R is one or more rare earth elements selected excluding Nd, Pr, and RH, the main phase 10 containing crystal grains based on an Nd₂Fe₁₄B crystal structure, wherein the main phase 10 includes the core portions 11c and 12c and the shell portions 11s and 12s covering the core portions 11c and 12c, and given R=La and/or Sm, the rare earth sintered magnet 1 includes the subphase 20 in addition to the first main phase 11 and the second main phase 12 described in the first embodiment. The subphase 20 includes the crystalline first subphase 21 having a main component based on an oxide phase represented by (Nd, Pr, RH, La, Sm)—O and the crystalline second subphase 22 having a main component represented by (Nd, Pr, RH, La)—O, the concentration of Sm is higher in the first subphase 21 than in the second subphase 22, and the first subphase 21 includes the Sm enrichment portion 41 in which Sm is selectively distributed. That is, the two types of main phases 10 and the two types of subphases 20 exist. As a result, it is possible to provide the rare earth sintered magnet 1 having excellent magnetic properties, such as temperature properties of magnetic properties, as compared with the related art. In addition, by setting R to La and Sm, the main phase 10 is in a state in which the first main phase 11 that satisfies C(Nd,RH)>CPr and the second main phase 12 that satisfies C(Nd,RH)<CPr are provided mixedly. In other words, in the rare earth sintered magnet 1, the main phase 10 having the two types of the first main phase 11 and the second main phase 12 exists, and focusing on the core portions 11c and 12c of the two types of main phases 10, the main phase 10 having the two types of core-shell structures is easily generated in which the Nd concentration is higher than the Pr concentration in the first main phase 11, conversely, the Pr concentration is higher than the Nd concentration in the second main phase 12, and the concentration of the heavy rare earth element RH in the first main phase 11 is higher than the concentration of the heavy rare earth element RH in the second main phase 12. As a result, the effect of improving the magnetic properties and having excellent magnetization as compared the related art, while reducing use of Nd and the heavy rare earth element RH as compared the related art, can be further enhanced.

### Third Embodiment

In the third embodiment, a method for producing the rare earth sintered magnet 1 described in the first embodiment and the second embodiment will be described separately as a method for producing a rare earth sintered magnet alloy that is the raw material of the rare earth sintered magnet 1 and a method for producing the rare earth sintered magnet 1 using the rare earth sintered magnet alloy.

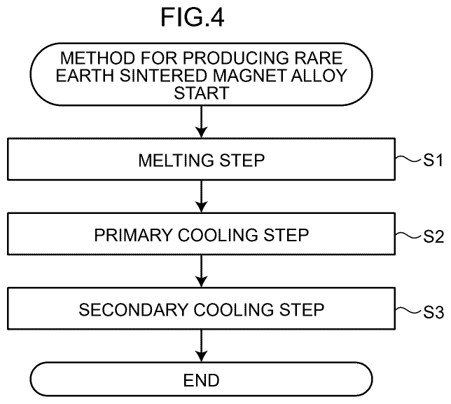

FIG. 4 is a flowchart illustrating an exemplary procedure of a method for producing a rare earth sintered magnet alloy according to the third embodiment. First, as illustrated in FIG. 4, the method for producing a rare earth sintered magnet alloy that is the raw material of the rare earth sintered magnet 1 includes a melting step (step S1) of heating and melting the raw material of the rare earth sintered magnet alloy containing an element constituting the rare earth sintered magnet 1 at a temperature of 1000K or higher, a primary cooling step (step S2) of cooling the molten raw material on a rotating body to obtain a solidified alloy, and a secondary cooling step (step S3) of further cooling the solidified alloy in a container. A rare earth sintered magnet alloy can thus be produced. Each step will be described below.

In the melting step S1, the raw material of the rare earth sintered magnet alloy is heated and melted at a temperature of 1000K or higher in a crucible in an atmosphere containing an inert gas such as argon (Ar) or in a vacuum. Consequently, the rare earth sintered magnet alloy melts into a molten alloy. As the raw material, Nd, Pr, RH, R, Fe, and B can be used. When the rare earth sintered magnet 1 of the second embodiment is produced, R is La and Sm. Examples of RH include Dy and Tb. As the raw material, FeB may be used instead of B. At this time, as the additive element M, one or more elements selected from the group consisting of Ga, Cu, Al, Co, Zr, Ti, Nb, and Mn may be contained in the raw material.

Next, in the primary cooling step S2, the molten alloy prepared in the melting step is fed to a tundish, and subsequently fed onto a single roll which is a rotating body. Consequently, the molten alloy is rapidly cooled on the single roll rotating in a predetermined direction, and a solidified alloy that is thinner than the ingot alloy is prepared on the single roll from the molten alloy. In this example, the single roll is used as the rotating body, but the present disclosure is not limited thereto, and twin rolls, a rotating disk, a rotating cylindrical mold, or the like may be used for rapid contact cooling. From the viewpoint of efficiently obtaining the thin solidified alloy, the cooling rate in the primary cooling step is preferably in the range of 10° C./s to 10⁷° C./s, and more preferably in the range of 10³° C./s to 10⁴° C./s. The thickness of the solidified alloy is in the range of 0.03 mm to 10 mm. The molten alloy starts to be solidified at the portion in contact with the single roll, and crystals grow in a columnar or needle shape in the thickness direction from the surface of contact with the single roll.

Thereafter, in the secondary cooling step S3, the thin solidified alloy prepared in the primary cooling step is placed in a tray container and cooled. When entering the tray container, the thin solidified alloy is crushed into scale-shaped (or flake-shaped) pieces of rare earth sintered magnet alloy and cooled. Depending on the cooling rate, ribbon-shaped pieces of rare earth sintered magnet alloy may be obtained, thus the present disclosure is not limited to the case of scale-shaped pieces. From the viewpoint of obtaining the rare earth sintered magnet alloy having a structure with favorable temperature properties of magnetic properties, the cooling rate in the secondary cooling step is preferably in the range of 10⁻²° C./s to 10⁵° C./s, and more preferably in the range of 10⁻¹° C./s to 10²° C./s.

The rare earth sintered magnet alloy obtained through these steps has a size in the minor axis direction of 3 μm to 10 μm, and a size in the major axis direction of 10 μm to 300 μm. In the case of the second embodiment, the rare earth sintered magnet alloy has a fine crystal structure containing a (Nd, Pr, RH, La, Sm)—Fe—B crystal phase and the crystalline subphase 20 of an oxide represented by (Nd, Pr, RH, La, Sm)—O. Hereinafter, the crystalline oxide subphase 20 represented by (Nd, Pr, RH, La, Sm)—O is referred to as the (Nd, Pr, RH, La, Sm)—O phase. The (Nd, Pr, RH, La, Sm)—O phase is a nonmagnetic phase consisting of an oxide having a relatively high concentration of rare earth elements. The thickness of the (Nd, Pr, RH, La, Sm)—O phase is 10 μm or less, corresponding to the width of the grain boundary. Having undergone the step of rapid cooling, the rare earth sintered magnet alloy produced with the above method step has a refined structure, compared with the rare earth sintered magnet alloy obtained with mold casting.

Next, a method for producing the rare earth sintered magnet 1 using the rare earth sintered magnet alloy will be described. FIG. 5 is a flowchart illustrating an exemplary procedure of a method for producing a rare earth sintered magnet according to the third embodiment. As illustrated in FIG. 5, the method for producing the rare earth sintered magnet 1 includes a pulverizing step (step S21) of pulverizing the rare earth sintered magnet alloy having the (Nd, Pr, RH, La, Sm)—Fe—B crystal phase and the (Nd, Pr, RH, La, Sm)—O phase, a molding step (step S22) of preparing a molded body by molding the pulverized rare earth sintered magnet alloy, a sintering step (step S23) of obtaining a sintered body by sintering the molded body at a sintering temperature that is a predetermined temperature, an aging step (step S24) of aging the sintered body in order to enhance the magnetic properties such as the coercive force of the rare earth sintered magnet 1, and a cooling step (step S25) of cooling the sintered body subjected to the aging process. Each step will be described below.

In the pulverizing step in step S21, the rare earth sintered magnet alloy having the (Nd, Pr, RH, La, Sm)—Fe—B crystal phase and the (Nd, Pr, RH, La, Sm)—O phase produced according to the rare earth sintered magnet alloy method step in FIG. 4 is pulverized into rare earth sintered magnet alloy powder having a grain size of 200 μm or less, preferably 0.5 μm to 100 μm, and more preferably about 1 μm to 10 μm in consideration of magnetizing ability. The pulverization of the rare earth sintered magnet alloy is performed using, in one example, an agate mortar, a stamp mill, a jaw crusher, or a jet mill. In particular, for reducing the grain size of the powder, it is preferable to pulverize the rare earth sintered magnet alloy in an atmosphere containing an inert gas. By pulverizing the rare earth sintered magnet alloy in an atmosphere containing an inert gas, it is possible to prevent oxygen from being mixed into the powder. However, unless the pulverization atmosphere affects the magnetic properties of the magnet, the rare earth sintered magnet alloy may be pulverized in the air. In a case where the rare earth sintered magnet 1 of the first embodiment is produced, La and Sm of the rare earth sintered magnet alloy used in producing the rare earth sintered magnet 1 of the second embodiment can be rare earth element R other than Nd, Pr, and the heavy rare earth element RH. That is, the rare earth sintered magnet alloy having the (Nd, Pr, RH, R)—Fe—B crystal phase and the (Nd, Pr, RH, R)—O phase is pulverized.

In the molding step S22, the powder of the rare earth sintered magnet alloy is compression-molded in a mold under a magnetic field to prepare a molded body. Here, the applied magnetic field can be 2T in one example. Note that the molding may be performed not in a magnetic field but without applying a magnetic field.

In the sintering step S23, the molded body generated by compression molding is held at a sintering temperature in the range of 950° C. to 1300° C., preferably 1000° C. or higher but lower than 1150° C., for between 0.1 hours and 10 hours, preferably 1.0 hour to 6.0 hours, whereby a sintered body is obtained. The sintering is preferably performed in an atmosphere containing an inert gas or in a vacuum in order to prevent oxidation. The sintering may be performed while applying a magnetic field.

In the case of FIG. 5, the aging step S24 includes a primary aging step S24-1, a secondary aging step S24-2, a tertiary aging step S24-3, and a quaternary aging step S24-4. The aging is preferably performed in an atmosphere containing an inert gas or in a vacuum in order to prevent oxidation.

In the primary aging step in step S24-1, the obtained sintered body is held at a primary aging temperature that is a temperature lower than the sintering temperature, specifically, at a temperature of 700° C. or higher but lower than 950° C., for 0.1 hours to 10 hours, preferably 0.5 hours to 5 hours.

In the secondary aging step in step S24-2, after the primary aging step, the sintered body held in the primary aging step is held at a secondary aging temperature that is a temperature lower than the primary aging temperature, specifically, at a temperature of 450° C. or higher but lower than 700° C., for 0.1 hours to 10 hours, preferably 1.0 hours to 7 hours.

In the tertiary aging step in step S24-3, after the secondary aging step, the sintered body held in the secondary aging step is heated again to the primary aging temperature, specifically a temperature of 700° C. or higher but lower than 950° C., and held at the primary aging temperature for 0.1 hours to 10 hours, preferably 0.5 hours to 5 hours.

In the quaternary aging step in step S24-4, after the tertiary aging step, the sintered body held in the tertiary aging step is held again at the secondary aging temperature, specifically a temperature of 450° C. or higher but lower than 700° C., for 0.1 hours to 10 hours, preferably 1.0 hour to 7 hours.

Finally, in the cooling step in step S25, the sintered body held in the quaternary aging step is held at a temperature lower than the secondary aging temperature, specifically, at a temperature of 200° C. or higher but lower than 450° C., for 0.1 hours to 5 hours. Thereafter, the rare earth sintered magnet 1 is completed by being cooled to room temperature. The cooling is also preferably performed in an atmosphere containing an inert gas or in a vacuum in order to prevent oxidation.

As described above, by controlling the temperature and time in the sintering step, the aging step, and the cooling step, the sintered body is repeatedly held in a temperature range in an unstable energy state. As a result, the first main phase 11 consisting of CNd>CPr and the second main phase 12 consisting of CNd<CPr are mixed, and the concentration of the heavy rare earth element RH in the first main phase 11 can be made higher than the concentration of the heavy rare earth element RH in the second main phase 12. In other words, the rare earth sintered magnet 1 has two types of main phases 10, i.e., the first main phase 11 and the second main phase 12, and focusing on the core portions 11c and 12c of the two types of main phases 10, the heavy rare earth element 1 can be produced characterized in that the sum of the Nd concentration and the concentration of the heavy rare earth element RH is higher than the Pr concentration in the first main phase 11, and conversely, the Pr concentration is higher than the sum of the Nd concentration and the concentration of the heavy rare earth element RH in the second main phase 12.

Furthermore, it is possible to produce the rare earth sintered magnet 1 including, in addition to the first main phase 11 and the second main phase 12 described in the first embodiment, the crystalline first subphase 21 having a main component based on an oxide phase represented by (Nd, Pr, RH, La, Sm)—O and the crystalline second subphase 22 having a main component represented by (Nd, Pr, RH, La)—O, and in which the concentration of Sm is higher in the first subphase 21 than in the second subphase 22, and the Sm enrichment portion 41 is formed in the first subphase 21.

Therefore, it is possible to provide the rare earth sintered magnet 1 having excellent magnetizing ability and magnetic properties as compared with the related art, while reducing use of Nd and the heavy rare earth element RH.

In the third embodiment, the rare earth sintered magnet alloy having the (Nd, Pr, RH, La, Sm)—Fe—B crystal phase and the (Nd, Pr, RH, La, Sm)—O phase is pulverized into rare earth sintered magnet alloy powder, which is then molded. Thereafter, the molded body is sintered to form a sintered body, and the sintered body is aged to become the rare earth sintered magnet 1. The rare earth sintered magnet 1 having the structure described in the second embodiment can thus be produced. In addition, since the rare earth sintered magnet alloy is produced after the heavy rare earth element is prepared to have a desired concentration, and the rare earth sintered magnet 1 is produced using the rare earth sintered magnet alloy, the heavy rare earth element RH easily enters the main phase 10.

In the third embodiment, the temperature and time in the sintering step, the aging step, and the sintered body cooling step are controlled. Especially in the primary aging step, the obtained sintered body is held at the primary aging temperature that is a temperature lower than the sintering temperature, specifically, at a temperature of 700° C. or higher but lower than 950° C., for 0.1 hours to 10 hours, preferably 0.5 hours to 5 hours. In the secondary aging step, the sintered body is held at the secondary aging temperature that is a temperature lower than the primary aging temperature, specifically, at a temperature of 450° C. or higher but lower than 700° C., for 0.1 hours to 10 hours, preferably 1.0 hour to 7 hours. In the tertiary aging step, the sintered body is heated again to the primary aging temperature, specifically a temperature of 700° C. or higher but lower than 950° C., and held at the primary aging temperature for 0.1 hours to 10 hours, preferably 0.5 hours to 5 hours. In the quaternary aging step, the sintered body is held again at the secondary aging temperature, specifically a temperature of 450° C. or higher but lower than 700° C., for 0.1 hours to 10 hours, preferably 1.0 hour to 7 hours. In this manner, the temperature and time are controlled so that two sets of the primary aging step and the secondary aging step are performed. This creates a state in which the sintered body is held repeatedly in a temperature range in an unstable energy state. As a result, the first main phase 11 consisting of CNd>CPr and the second main phase 12 consisting of CNd<CPr are mixed, and the concentration of the heavy rare earth element RH in the first main phase 11 can be made higher than the concentration of the heavy rare earth element RH in the second main phase 12. In other words, the rare earth sintered magnet 1 has two types of main phases 10, i.e., the first main phase 11 and the second main phase 12, and focusing on the core portions 11c and 12c of the two types of main phases 10, the heavy rare earth element 1 can be selectively produced in which the sum of the concentration of Nd and the concentration of the heavy rare earth element RH is higher than the concentration of Pr in the first main phase 11, and conversely, the concentration of Pr is higher than the sum of the concentration of Nd and the concentration of the heavy rare earth element RH in the second main phase 12.

Furthermore, through the above production steps, it is possible to selectively produce the rare earth sintered magnet 1 including the crystalline first subphase 21 having a main component based on an oxide phase represented by (Nd, Pr, RH, La, Sm)—O and the crystalline second subphase 22 having a main component represented by (Nd, Pr, RH, La)—O, and having a characteristic structure that the concentration of Sm is higher in the first subphase 21 than in the second subphase 22, and the Sm enrichment portion 41 is formed in the first subphase 21.

Comparing with the R-T-B-based sintered magnet described in Patent Literature 1, the R-T-B-based sintered magnet described in Patent Literature 1 has one or more rare earth elements essentially including the heavy rare earth element RH, and has one kind of main phase grain composed of a core portion and a shell portion. That is, in Patent Literature 1, the heavy rare earth element RH is contained in all the main phase grains. On the other hand, in the main phase 10 of the rare earth sintered magnet 1 according to the first embodiment, the first main phase 11 in which the heavy rare earth element RH is contained in the core portion 11c and the second main phase 12 in which the heavy rare earth element RH is hardly contained in the core portion 12c are mixed. That is, the heavy rare earth element RH is selectively disposed in the first main phase 11 which is one of the two types of main phases 10. As described above, compared with the R-T-B-based sintered magnet described in Patent Literature 1 in which the heavy rare earth element RH must be contained in all the main phases of only one kind, the rare earth sintered magnet 1 according to the first embodiment in which only the first main phase 11 which is one of the two types of main phases 10 needs to contain the heavy rare earth element RH can reduce the amount of the heavy rare earth element RH used. In addition, since the ratio of the volume of the subphase 20 to the total volume of the rare earth sintered magnet 1 is extremely small, even though the heavy rare earth element RH is diffused and present in the subphase 20, the amount of the heavy rare earth element RH used can be reduced as compared with the technique of Patent Literature 1.

In addition, comparing with the technique described in Patent Literature 2, in order to obtain magnetic properties equivalent to those of the rare earth sintered magnet 1 according to the first embodiment with the rare earth magnet produced with the technique described in Patent Literature 2, as will be described later, a large amount of the heavy rare earth element RH has to be added as compared with the rare earth sintered magnet 1 according to the first embodiment. That is, the rare earth sintered magnet 1 according to the first embodiment can reduce the amount of the heavy rare earth element RH used as compared with the technique described in Patent Literature 2 when trying to obtain the same magnetic properties. The method described in Patent Literature 2 includes hot working, but the method for producing the rare earth sintered magnet 1 according to the third embodiment does not include hot working. Therefore, reduction in the particle size of the main phase 10 is prevented, and degradation of the residual magnetic flux density and magnetization can be reduced as compared with the rare earth magnet produced with the technique described in Patent Literature 2.

As a result, it is possible to obtain the rare earth sintered magnet 1 capable of improving magnetic properties as compared with the related art, while reducing use of the heavy rare earth element RH as compared with the related art.

### Fourth Embodiment

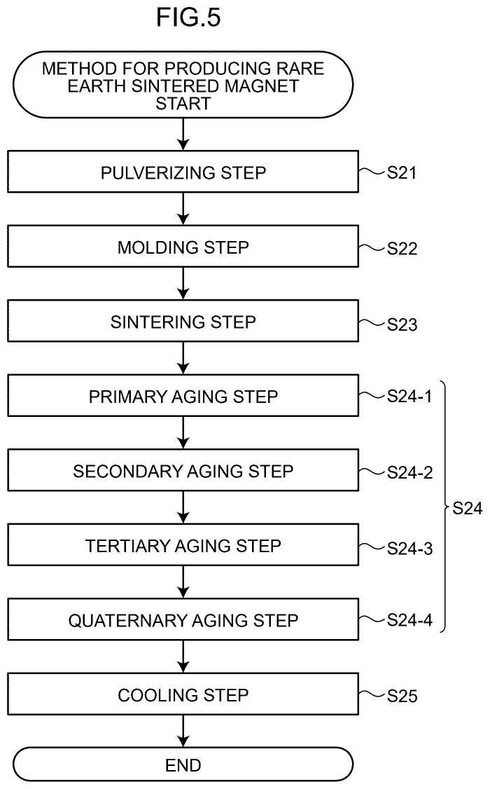

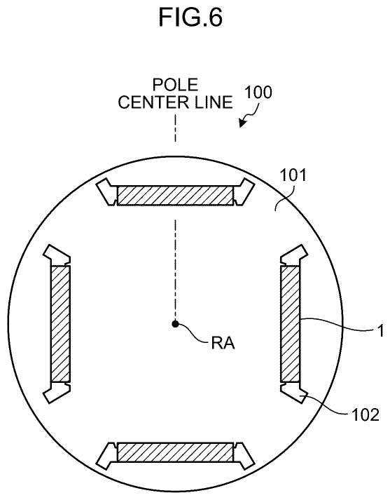

In the fourth embodiment, a rotor using the rare earth sintered magnet 1 according to the first embodiment or the second embodiment produced with the production method according to the third embodiment will be described. FIG. 6 is a cross-sectional view schematically illustrating an exemplary configuration of a rotor equipped with a rare earth sintered magnet according to the fourth embodiment. FIG. 6 shows a cross section in a direction perpendicular to a rotation axis RA of a rotor 100.

The rotor 100 is rotatable about the rotation axis RA. The rotor 100 includes a rotor core 101 and the rare earth sintered magnet 1 inserted into a magnet insertion hole 102 provided in the rotor core 101 along the circumferential direction of the rotor 100. FIG. 6 illustrates an example in which the four magnet insertion holes 102 are provided in the rotor core 101 and the four rare earth sintered magnets 1 are inserted into the magnet insertion holes 102, but the number of magnet insertion holes 102 and the number of the rare earth sintered magnets 1 may be changed according to the design of the rotor 100. The rotor core 101 is formed by a plurality of disk-shaped electromagnetic steel sheets stacked in the axial direction of the rotation axis RA.

The rare earth sintered magnets 1 are produced with the production method described in the third embodiment. Each of the four rare earth sintered magnets 1 is inserted into the corresponding magnet insertion hole 102. The four rare earth sintered magnets 1 are magnetized such that the magnetic poles of the rare earth sintered magnets 1 on the radially outer side of the rotor 100 differ between adjacent rare earth sintered magnets 1.

As described above, the rotor 100 according to the fourth embodiment includes the rare earth sintered magnet 1 according to the first embodiment or the second embodiment capable of improving magnetic properties at room temperature and preventing degradation of magnetic properties associated with temperature rise. Thus, because of the rare earth sintered magnet 1 capable of preventing degradation of magnetic properties associated with temperature rise while reducing use of the heavy rare earth element RH as compared with the related art and maintaining high residual magnetic flux density and coercive force, degradation of magnetic properties is prevented even in a high temperature environment exceeding 100° C. As a result, it is possible to improve magnetic properties and magnetization while substituting inexpensive rare earth elements for Nd and the heavy rare earth element RH that are expensive and have a procurement risk due to high distribution unevenness, and to stabilize the operation of the rotor 100 even in a high temperature environment exceeding 100° C. Furthermore, since the rare earth sintered magnet 1 according to the the first embodiment or the second embodiment has excellent magnetizing ability as compared with the related art, magnetization is possible in an assembled state in which the rare earth sintered magnets 1 are set on the rotor 100, so that handling in the process of production is facilitated. Furthermore, the magnetization process with reduced voltage can be implemented, which contributes to energy saving.

### Fifth Embodiment

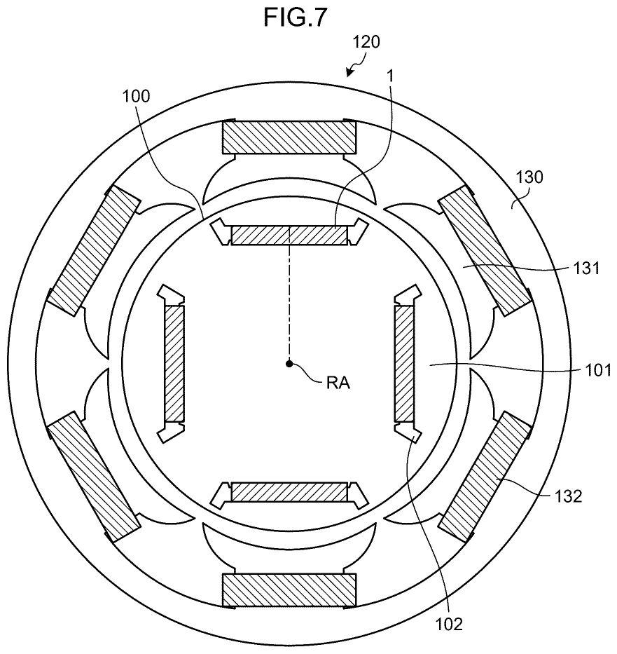

In the fifth embodiment, a rotary machine equipped with the rotor 100 according to the fourth embodiment will be described. FIG. 7 is a cross-sectional view schematically illustrating an exemplary configuration of a rotary machine according to the fifth embodiment. FIG. 7 shows a cross section in a direction perpendicular to the rotation axis RA of the rotor 100.

The rotary machine 120 includes the rotor 100 described in the fourth embodiment, which is rotatable about the rotation axis RA, and an annular stator 130 provided coaxially with the rotor 100 and facing the rotor 100. The stator 130 is formed by stacking a plurality of electromagnetic steel sheets in the axial direction of the rotation axis RA. Another existing configuration can be adopted as the configuration of the stator 130, instead of the described one. In the stator 130, teeth 131 protruding toward the rotor 100 side are provided along the inner surface of the stator 130. Windings 132 are provided on the teeth 131. The winding type of the windings 132 may be concentrated winding or distributed winding in one example. That is, the stator 130 has an annular structure facing the rotor 100 and including, on an inner surface on a side where the rotor 100 is placed, the teeth 131 protruding toward the rotor 100 and the windings 132 provided on the teeth 131. The number of magnetic poles of the rotor 100 in the rotary machine 120 should be not less than two, that is, the number of rare earth sintered magnets 1 should be not less than two. Although an example of the rotor 100 of the interior magnet type is illustrated in FIG. 7, the rotor 100 may be of the surface magnet type in which the rare earth sintered magnets 1 are fixed to the outer circumference of the rotor with an adhesive.

As described above, the rotary machine 120 according to the fifth embodiment includes the rare earth sintered magnet 1 according to the first embodiment or the second embodiment which is capable of improving magnetic properties at room temperature and preventing degradation of magnetic properties associated with temperature rise. Thus, because of the rare earth sintered magnet 1 capable of preventing degradation of magnetic properties associated with temperature rise while reducing use of heavy rare earth elements as compared with the related art and maintaining high residual magnetic flux density and coercive force, degradation of magnetic properties is prevented even in a high temperature environment exceeding 100° C. As a result, it is possible to improve magnetic properties and magnetization while substituting inexpensive rare earth elements for Nd and the heavy rare earth element that are expensive and have a procurement risk due to high distribution unevenness, and to stably drive the rotor 100 and stabilize the operation of the rotary machine 120 even in a high temperature environment exceeding 100° C.

### EXAMPLES

Hereinafter, the rare earth sintered magnet 1 according to the present disclosure will be described in detail with reference to Examples and Comparative Examples.

In Examples 1 to 8, the rare earth sintered magnet 1 is produced with the method described in the third embodiment using (Nd, Pr, Tb, La, Sm)—Fe—B-based samples of a plurality of rare earth sintered magnet alloys that differ in composition. In Examples 1 to 8, the rare earth sintered magnet 1 is produced using the rare earth sintered magnet alloys that differ in the content of Nd, Pr, Tb, La, and Sm. That is, in Examples 1 to 8, the rare earth sintered magnet 1 is produced using the rare earth sintered magnet alloy represented by (Nd, Pr, Tb, La, Sm)—Fe—B with the production method described in the third embodiment.

In Comparative Examples 1 to 14, the rare earth sintered magnet 1 is experimentally produced using R—Fe—B-based samples of a plurality of rare earth sintered magnet alloys that differ in composition with a general rare earth magnet production method as disclosed in Patent Literature 1 or Patent Literature 2. The samples of the rare earth sintered magnets 1 according to Comparative Examples 1 to 14 differ in R.

In Comparative Examples 1 to 7, the rare earth sintered magnet 1 is produced from a rare earth sintered magnet alloy in which R is Nd or using a rare earth sintered magnet alloy in which R includes Nd and one or more elements selected from the group consisting of Tb, Pr, La, and Sm with the production method disclosed in Patent Literature 1.

In Comparative Examples 8 to 14, the rare earth sintered magnet 1 is produced from a rare earth sintered magnet alloy in which R is Nd or using a rare earth sintered magnet alloy in which R includes Nd and one or more elements selected from the group consisting of Tb, Pr, La, and Sm with the production method disclosed in Patent Literature 2. The production method disclosed in Patent Literature 2 includes a step of subjecting a sintered body to hot working.

Table 3 shows the general formulas of the rare earth sintered magnets according to Examples and Comparative Examples, the content of elements constituting R, the results of analysis of structure forms, and the results of determination of magnetic properties and magnetizing ability. Table 3 shows the general formula of the main phase 10 of each sample which is the rare earth sintered magnet 1 according to Examples 1 to 8 and Comparative Examples 1 to 14.

TABLE 3

| | | | | | | | Structure form | |
|---|---|---|---|---|---|---|---|---|
| | | | | | | | Main phase | |
| | | Content(at %) | | | | | First main phase | Second main phase |
| | General formula | Nd | Pr | La | Sm | Tb | (C(Nd, RH) > CPr)) | (C(Nd, RH) < CPr)) |
| Comparative | (Nd, Tb)—Fe—B | 10.01 | — | — | — | 1.12 | x | x |
| example 1 | | | | | | | | |
| Comparative | Nd—Fe—B | 11.23 | — | — | — | — | x | x |
| example 2 | | | | | | | | |
| Comparative | (Nd, Pr)—Fe—B | 8.83 | 2.94 | — | — | — | x | x |
| example 3 | | | | | | | | |
| Comparative | (Nd, Pr, Tb)—Fe—B | 8.03 | 2.62 | — | — | 1.12 | x | x |
| example 4 | | | | | | | | |
| Comparative | (Nd, La, Sm)—Fe—B | 9.66 | — | 1.03 | 1.07 | — | x | x |
| example 5 | | | | | | | | |
| Comparative | (Nd, La, Sm)—Fe—B | 11.64 | — | 0.51 | 0.45 | — | x | x |
| example 6 | | | | | | | | |
| Comparative | (Nd, Pr, La, Sm)—Fe—B | 7.65 | 2.35 | 0.59 | 0.55 | — | x | x |
| example 7 | | | | | | | | |
| Comparative | (Nd, Tb)—Fe—B | 10.01 | — | — | — | 1.12 | x | x |
| example 8 | | | | | | | | |
| Comparative | Nd—Fe—B | 11.23 | — | — | — | — | x | x |
| example 9 | | | | | | | | |
| Comparative | (Nd, Pr)—Fe—B | 8.83 | 2.94 | — | — | — | x | ∘ |
| example 10 | | | | | | | | |
| Comparative | (Nd, Pr, Tb)—Fe—B | 8.03 | 2.62 | — | — | 1.12 | x | ∘ |
| example 11 | | | | | | | | |
| Comparative | (Nd, La, Sm)—Fe—B | 9.66 | — | 1.03 | 1.07 | — | x | x |
| example 12 | | | | | | | | |
| Comparative | (Nd, La, Sm)—Fe—B | 11.64 | — | 0.51 | 0.45 | — | x | x |
| example 13 | | | | | | | | |
| Comparative | (Nd, Pr, La, Sm)—Fe—B | 8.25 | 2.35 | 0.59 | 0.56 | — | x | ∘ |
| example 14 | | | | | | | | |
| Example 1 | (Nd, Pr, Tb, La, Sm)—Fe—B | 8.18 | 1.13 | 1.03 | 1.07 | 0.10 | ∘ | ∘ |
| Example 2 | (Nd, Pr, Tb, La, Sm)—Fe—B | 8.89 | 1.66 | 0.51 | 0.45 | 0.20 | ∘ | ∘ |
| Example 3 | (Nd, Pr, Tb, La, Sm)—Fe—B | 9.45 | 1.41 | 0.23 | 0.21 | 0.35 | ∘ | ∘ |
| Example 4 | (Nd, Pr, Tb, La, Sm)—Fe—B | 7.99 | 3.14 | 0.05 | 0.05 | 0.52 | ∘ | ∘ |
| Example 5 | (Nd, Pr, Tb, La, Sm)—Fe—B | 8.63 | 1.86 | 0.53 | 0.21 | 0.39 | ∘ | ∘ |
| Example 6 | (Nd, Pr, Tb, La, Sm)—Fe—B | 8.65 | 1.94 | 0.23 | 0.52 | 0.33 | ∘ | ∘ |
| Example 7 | (Nd, Pr, Tb, La, Sm)—Fe—B | 10.95 | 1.37 | 0.05 | 0.05 | 0.68 | ∘ | ∘ |
| Example 8 | (Nd, Pr, Tb, La, Sm)—Fe—B | 10.02 | 1.31 | 0.11 | 0.12 | 0.45 | ∘ | ∘ |

| | Structure form | | Determination | | | | |
|---|---|---|---|---|---|---|---|
| | Subphase | | | | Temperature | | |
| | First | Second | Residual | | coefficient | Temperature | |
| | subphase | subphase | magnetic | | of residual | coefficient | |
| | (High Sm | (Low Sm | flux | Coercive | magnetic | of coercive | Magnetizing |
| | concentration) | concentration) | density | force | flux density | force | ability |
| Comparative | x | x | — | — | — | — | — |
| example 1 | | | | | | | |
| Comparative | x | x | Good | Poor | Equivalent | Equivalent | Equivalent |
| example 2 | | | | | | | or better |
| Comparative | x | x | Good | Poor | Equivalent | Poor | Equivalent |
| example 3 | | | | | | | or better |
| Comparative | x | x | Equivalent | Good | Equivalent | Poor | Equivalent |
| example 4 | | | | | | | or better |
| Comparative | ∘ | x | Good | Poor | Equivalent | Good | Equivalent |
| example 5 | | | | | | | or better |
| Comparative | ∘ | x | Good | Poor | Good | Good | Equivalent |
| example 6 | | | | | | | or better |
| Comparative | ∘ | x | Good | Poor | Good | Equivalent | Equivalent |
| example 7 | | | | | | | or better |
| Comparative | x | x | Poor | Good | Equivalent | Equivalent | Poor |
| example 8 | | | | | | | |
| Comparative | x | x | Poor | Good | Equivalent | Equivalent | Poor |
| example 9 | | | | | | | |
| Comparative | x | x | Poor | Good | Equivalent | Equivalent | Poor |
| example 10 | | | | | | | |
| Comparative | x | x | Poor | Good | Equivalent | Equivalent | Poor |
| example 11 | | | | | | | |
| Comparative | ∘ | x | Poor | Good | Good | Good | Poor |
| example 12 | | | | | | | |
| Comparative | ∘ | x | Poor | Good | Good | Good | Poor |
| example 13 | | | | | | | |
| Comparative | ∘ | x | Poor | Good | Good | Good | Poor |
| example 14 | | | | | | | |
| Example 1 | ∘ | ∘ | Good | Good | Good | Good | Equivalent |
| | | | | | | | or better |
| Example 2 | ∘ | ∘ | Good | Good | Good | Good | Equivalent |
| | | | | | | | or better |
| Example 3 | ∘ | ∘ | Good | Good | Good | Good | Equivalent |
| | | | | | | | or better |
| Example 4 | ∘ | ∘ | Good | Good | Good | Good | Equivalent |
| | | | | | | | or better |
| Example 5 | ∘ | ∘ | Good | Good | Good | Good | Equivalent |
| | | | | | | | or better |
| Example 6 | ∘ | ∘ | Good | Good | Good | Good | Equivalent |
| | | | | | | | or better |
| Example 7 | ∘ | ∘ | Good | Good | Good | Good | Equivalent |
| | | | | | | | or better |
| Example 8 | ∘ | ∘ | Good | Good | Good | Good | Equivalent |
| | | | | | | | or better |

Next, a method for analyzing the structure of the rare earth sintered magnet 1 according to Examples 1 to 8 and Comparative Examples 1 to 14 will be described. The structure form of the rare earth sintered magnet 1 is determined by elemental analysis using a scanning electron microscope (SEM) and EPMA. Here, as the SEM and EPMA, a field emission electron probe micro analyzer (FE-EPMA) (JEOL Ltd., product name: JXA-8530F) is used. Conditions for the elemental analysis are as follows: acceleration voltage: 15.0 kV, irradiation current: 2.271e⁻⁰⁰⁸ A, irradiation time: 130 ms, number of pixels: 512 pixels×512 pixels, magnification: 5000 times, number of integrations: one.

Next, a method for evaluating the magnetic properties of the rare earth sintered magnet 1 according to Examples 1 to 8 and Comparative Examples 1 to 14 will be described. The evaluation of the magnetic properties is performed by measuring the coercive force of a plurality of samples using a pulse excitation BH tracer. The maximum applied magnetic field obtained by the BH tracer is equal to or greater than 6 T, at which the rare earth sintered magnet 1 is completely magnetized. In addition to the pulse excitation BH tracer, a direct current self-registering magnetometer also called a direct current BH tracer, a vibrating sample magnetometer (VSM), a magnetic property measurement system (MPMS), a physical property measurement system (PPMS), or the like may be used, as long as a maximum applied magnetic field of 6T or more can be generated. The measurement is performed in an atmosphere containing an inert gas such as nitrogen. The magnetic properties of each sample are measured by detecting magnetization picked up by a search coil or a magnetic sensor on the rare earth sintered magnet 1 magnetized by an applied magnetic field. Magnetic properties are measured from a J-H curve or a B—H curve which is the measured magnetic hysteresis. The magnetic properties of each sample are measured at a first measurement temperature T1 and a second measurement temperature T2 different from each other. The temperature coefficient α[%/° C.] of residual magnetic flux density is a value obtained by computing the ratio of the difference between the residual magnetic flux density at the first measurement temperature T1 and the residual magnetic flux density at the second measurement temperature T2 to the residual magnetic flux density at the first measurement temperature T1, and dividing the ratio by the difference in temperature (T2−T1). The temperature coefficient β [%/° C.] of coercive force is a value obtained by computing the ratio of the difference between the coercive force at the first measurement temperature T1 and the coercive force at the second measurement temperature T2 to the coercive force at the first measurement temperature T1, and dividing the ratio by the difference in temperature (T2−T1). Therefore, the smaller the absolute values |α| and |β| of the temperature coefficients of the magnetic properties, the more effectively the degradation of the magnetic properties of the magnet with respect to temperature rise is prevented.

Furthermore, the measurement of magnetizing ability is obtained by calculating the magnetization rate based on the ratio between the magnetic flux density measured by the magnetic hysteresis drawn by applying an arbitrary magnetic field and the magnetic flux density measured by the magnetic hysteresis drawn by applying a saturated magnetic field, at a constant permeance coefficient. When higher magnetization rate is obtained with lower magnetic field, it can be said that the magnetizing ability is high.

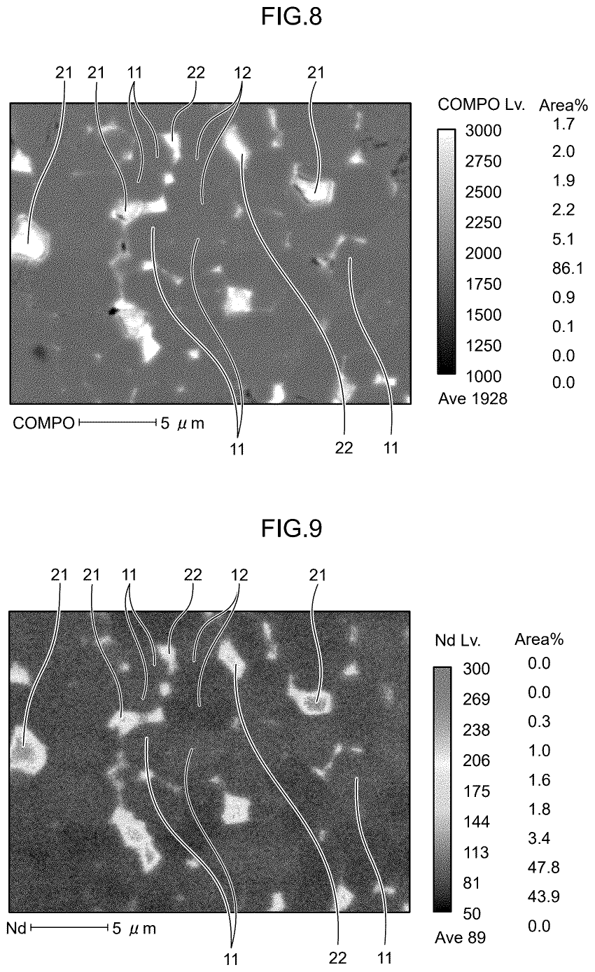

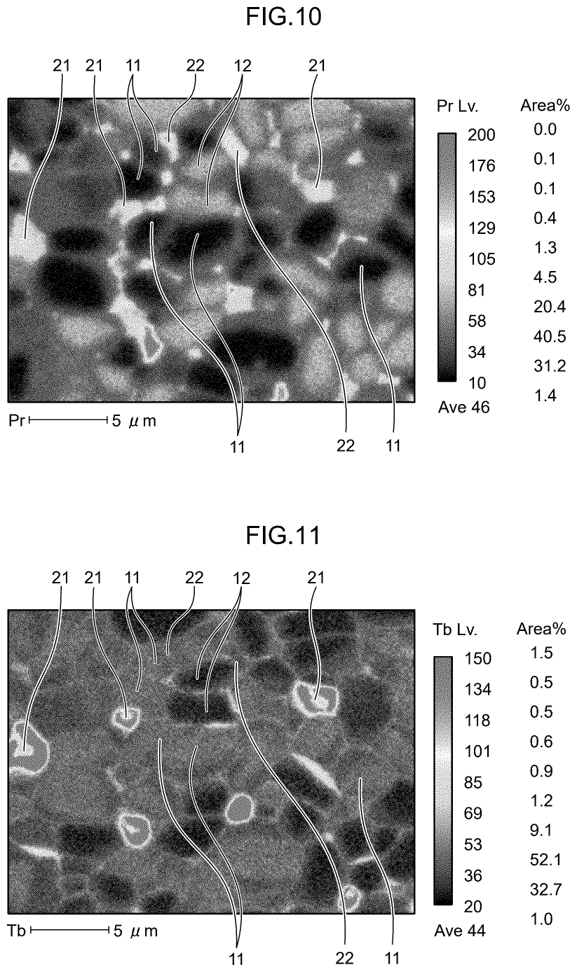

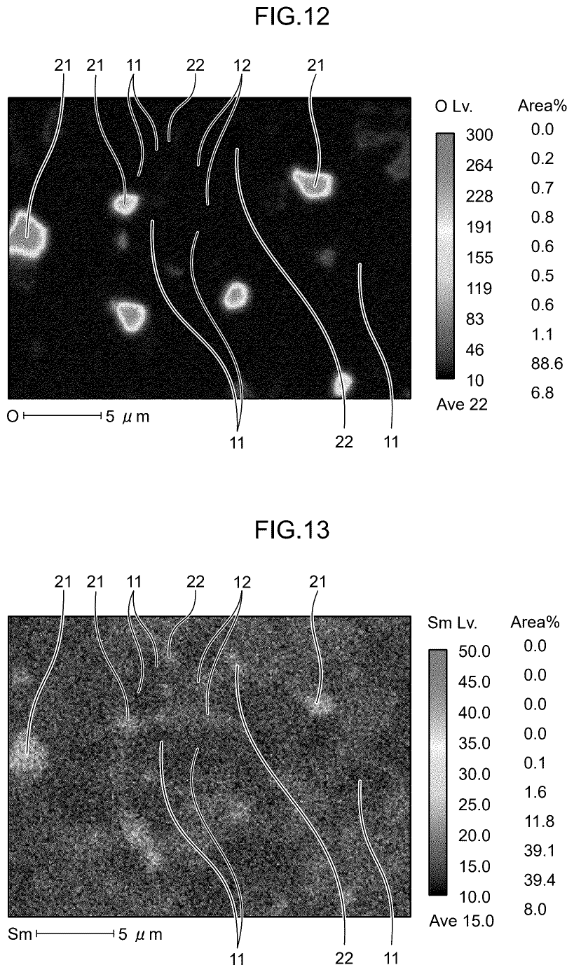

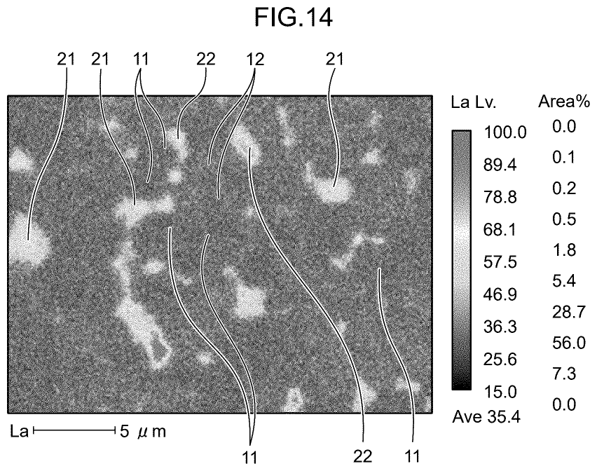

First, the results of analysis of the samples according to Examples 1 to 8 and Comparative Examples 1 to 14 will be described. FIG. 8 is a trace of a composition image obtained by analyzing a cross section of a rare earth sintered magnet according to Examples 1 to 8 with FE-EPMA. FIGS. 9 to 14 are element maps obtained by analyzing a cross section of a rare earth sintered magnet according to Examples 1 to 8 with FE-EPMA. FIG. 9 is an element map of Nd, FIG. 10 is an element map of Pr, FIG. 11 is an element map of Tb, FIG. 12 is an element map of O, FIG. 13 is an element map of Sm, and FIG. 14 is an element map of La. Note that FIGS. 9 to 14 are the element maps corresponding to the region illustrated in FIG. 8. Since the rare earth sintered magnets 1 according to Examples 1 to 8 all yield similar results, FIGS. 8 to 14 depict representative ones of Examples 1 to 8. Furthermore, components that are the same as those in FIGS. 1 and 2 are denoted by the same reference signs.

As illustrated in FIGS. 9 to 11, in each sample of Examples 1 to 8, it is confirmed that the main phase 10 that satisfies a general formula (Nd, Pr, Tb, R)—Fe—B, where RH is Tb, R is one or more rare earth elements selected excluding Nd, Pr, and RH, the main phase 10 containing crystal grains based on an Nd₂Fe₁₄B crystal structure, includes the core portions 11c and 12c and the shell portions 11s and 12s covering the core portions 11c and 12c. In addition, it is confirmed that in the main phase 10, the first main phase 11 that satisfies CNd>CPr and the second main phase 12 that satisfies CNd<CPr are provided mixedly. It is also confirmed that given that the concentration of Tb of the first main phase 11 is C1Tb and the concentration of Tb of the second main phase 12 is C2Tb, C1Tb>C2Tb is satisfied.

Here, the concentration difference indicated by “the first main phase 11 that satisfies CNd>CPr and the second main phase 12 that satisfies CNd<CPr” means that there is a clear difference between the detection intensity of Nd and the detection intensity of Pr by mapping analysis using EPMA. Specifically, taking the case of the first main phase 11 as an example, the EPMA detection intensity of the concentration of Nd in the core portion 11c is higher than the average, and the EPMA detection intensity of the concentration of Pr indicates around the lower limit. The case in the second main phase 12 is the reverse of the case in the first main phase 11.

More specifically, taking the mapping diagram of Nd in FIG. 9 and the mapping diagram of Pr in FIG. 10 as examples, the average of the detection levels of Nd with EPMA is 89, and the average of the detection levels of Pr is 46. In the case of the first main phase 11, CNd is higher than 89, CPr is around the lower limit value, and there is a clear concentration difference. In addition, since the second main phase 12 is the reverse of the first main phase 11, CPr is higher than 46, CNd is around the lower limit value, and there is a clear concentration difference.

Here, the concentration difference indicated by “C1Tb>C2Tb” means that there is a clear difference between the detection intensity of Tb in the first main phase 11 and the detection intensity of Tb in the second main phase 12 by mapping analysis using EPMA, Specifically, the EPMA detection intensity of the concentration of Tb in the first main phase 11 is higher than the average, and the EPMA detection intensity of the concentration of Tb in the second main phase 12 indicates around the lower limit.

More specifically, taking the mapping diagram of Tb of FIG. 11 as an example, the average of the detection levels of Tb with EPMA is 44. In the case of the first main phase 11, CTb is higher than 44, but in the case of the second main phase 12, CTb is around the lower limit value, and there is a clear concentration difference.

As illustrated in FIGS. 12 to 14, given R=La and/or Sm, the rare earth sintered magnet 1 includes the first subphase 21 that is crystalline and has a main component based on an oxide phase represented by (Nd, Pr, Tb, La, Sm)—O, and the second subphase 22 that is crystalline and has a main component represented by (Nd, Pr, Tb, La)—O, in addition to the first main phase 11 and the second main phase 12 in the first embodiment. It is confirmed that the concentration of Sm is higher in the first subphase 21 than in the second subphase 22.

In Table 3, given that the sum of the concentration of Nd and the concentration of Tb which is the heavy rare earth element RH is denoted by C(Nd,Tb), “∘” is input in the columns of the first main phase 11 and the second main phase 12 for the samples in which the states of the first main phase 11 that satisfies C(Nd,RH)>CPr and the second main phase 12 that satisfies C(Nd,RH)<CPr are confirmed, and “x” is input in the columns of the first main phase 11 and the second main phase 12 for the samples in which such states are not confirmed. The concentration difference of inequality signs means that there is a clear difference between the detection intensity of Nd and Tb and the detection intensity of Pr. As a specific example, the case of the first main phase 11 indicates that the EPMA detection intensity of the concentration of Nd and the concentration of Tb is higher than the average, and the EPMA detection intensity of the concentration of Pr is around the lower limit. The case in the second main phase 12 is the reverse of the case in the first main phase 11. When only C(Nd,RH)<CPr as in the second main phase 12 is confirmed, “∘” is input only in the column of the second main phase 12, and “x” is input in the column of the first main phase 11.

Further, in Table 3, for samples confirmed to have the crystalline first subphase 21 based on an oxide phase having a main component represented by (Nd, Pr, Tb, La, Sm)—O and the crystalline second subphase 22 having a main component represented by (Nd, Pr, Tb, La)—O, and confirmed that the concentration of Sm is higher in the first subphase 21 than in the second subphase 22, “∘” is input in each of the columns of the first subphase 21 and the second subphase 22, and for samples which are not confirmed so, “x” is input in each of the columns of the first subphase 21 and the second subphase 22. In addition, in a case where there is only one subphase 20 or there is no Sm concentration difference between the subphases 20, “∘” is input only in the column of the first subphase 21, and “x” is input in the column of the second subphase 22, assuming that there is only the first subphase 21. Note that the concentration difference between the first subphase 21 and the second subphase 22 means that the detection intensity of Sm is higher on average in the first subphase 21 than in the second subphase 22 by mapping analysis using EPMA. Specifically, taking the mapping diagram of Sm in FIG. 13 as an example, the average value of the detection levels of Sm with EPMA is 15.0, and the first subphase 21 is higher than 15.0 whereas the second subphase 22 is lower than 15.0, indicating that a detection in a state of aggregation cannot be performed.

In addition, from the intensity ratio of the element map obtained by analysis with FE-EPMA, it is also confirmed that the number of first main phases 11 that are C(Nd,RH)>CPr is larger than the number of second main phases 12 that are C(Nd,RH)<CPr. Focusing on the shell portions 11s and 12s of the core-shell structure, it is also confirmed that the first main phase 11 satisfies the relational expressions of CNd>SNd, CPr<SPr, and CTb>STb, and the second main phase 12 satisfies the relational expressions of CNd<SNd, CPr>SPr, and CTb<STb.

Next, the results of measurement of the magnetic properties in each sample according to Examples 1 to 8 and Comparative Examples 1 to 14 will be described. The shape of each sample that is the subject of magnetic measurement is a block shape having a length of 7 mm, a width of 7 mm, and a height of 7 mm. The first measurement temperature T1 is 23° C., and the second measurement temperature T2 is 200° C. 23° C. is room temperature. 200° C. of the second measurement temperature T2 is a temperature that can occur as an environment in which automobile motors and industrial motors operate.

First, the residual magnetic flux density and the coercive force in each sample according to Examples 1 to 8 and Comparative Examples 2 to 14 are determined in comparison with Comparative Example 1. When the values of the residual magnetic flux density and the coercive force of each sample at 23° C. are within an allowable measurement error of 1% compared with the values of Comparative Example 1, the values are rated as “equivalent”. Values of 1% or more higher are rated as “good”, and values of 18 or more lower are rated as “poor”.

Next, the temperature coefficient α of residual magnetic flux density is calculated using the residual magnetic flux density at the first measurement temperature T1 of 23° C. and the residual magnetic flux density at the second measurement temperature T2 of 200° C. The temperature coefficient β of coercive force is calculated using the coercive force at the first measurement temperature T1 of 23° C. and the coercive force at the second measurement temperature T2 of 200° C. The temperature coefficient of residual magnetic flux density and the temperature coefficient of coercive force in each sample according to Examples 1 to 8 and Comparative Examples 2 to 14 are determined in comparison with Comparative Example 1. When the values of each sample are within an allowable measurement error of +1% compared with the absolute value |α| of the temperature coefficient of residual magnetic flux density and the absolute value |β| of the temperature coefficient of coercive force in the sample of Comparative Example 1, the values are rated as “equivalent”. Values of −1% or more lower are rated as “good”, and values of +1% or more higher are rated as “poor”. Because the samples determined to be “good” have a smaller temperature coefficient, it is possible to provide the rare earth sintered magnet 1 having stable magnetic properties even in a high temperature environment while preventing degradation of magnetic properties associated with temperature rise.

Next, regarding the magnetizing ability, the magnetization rate is calculated from the ratio of the magnetic flux density, which is one intersection of the magnetic hysteresis of the applied magnetic field of 20 kde and the permeance coefficient Pc, and the magnetic flux density, which is one intersection of the magnetic hysteresis of the applied magnetic field of 80 kde in the saturation magnetization state and the permeance coefficient Pc. The magnetizing ability in each sample according to Examples 1 to 8 and Comparative Examples 2 to 14 is determined in comparison with Comparative Example 1. That is, for each sample, compared with the magnetization rate in the sample according to Comparative Example 1, values of −1% or more higher, being considered as a measurement error, are rated as “equivalent or better”, and values of −1% or more lower are rated as “poor”. It is possible to provide the rare earth sintered magnet 1 having high magnetizing ability for samples rated as “equivalent or better”.

The results of determination of the residual magnetic flux density, the coercive force, the temperature coefficient of residual magnetic flux density, the temperature coefficient of coercive force, and the magnetizing ability are shown in Table 3.

Comparative Example 1 is a sample of the rare earth sintered magnet 1 prepared in the form of (Nd,Tb)—Fe—B with the production method described in Patent Literature 1 using Nd,Tb, Fe, and FeB as raw materials. From the observation of the structure form of this sample with the method described above, due to the absence of Pr, La, and Sm, no core-shell structure is confirmed in the main phase 10, and it is not confirmed that the concentration of Sm in the subphase 20 is higher in the first subphase 21 than in the second subphase 22. The evaluation of the magnetic properties of this sample with the method described above shows that the residual magnetic flux density Bᵣ is 1.25 T and the coercive force Hou is 1600 kA/m. The temperature coefficients of residual magnetic flux density and coercive force are |x|=0.185%/C and |β|=0.455%/° C., respectively. The magnetization rate is 98.6%. These values of Comparative Example 1 are used as a reference.

Comparative Example 2 is a sample of the rare earth sintered magnet 1 prepared in the form of Nd—Fe—B with the production method described in Patent Literature 1 using Nd, Fe, and FeB as raw materials. From the observation of the structure form of this sample with the method described above, due to the absence of Pr, La, and Sm, no core-shell structure is confirmed in the main phase 10, and it is not confirmed that the concentration of Sm in the subphase 20 is higher in the first subphase 21 than in the second subphase 22. The evaluation of the magnetic properties of this sample with the method described above shows that the residual magnetic flux density is “good” and the coercive force is “poor” because Tb which is the heavy rare earth element RH are not in the main phase 10. In addition, the temperature coefficient of the residual magnetic flux density is “equivalent”, the temperature coefficient of the coercive force is “equivalent”, and the magnetizing ability is “equivalent or better”.

Comparative Example 3 is a sample of the rare earth sintered magnet 1 prepared in the form of (Nd, Pr)—Fe—B with the production method described in Patent Literature 1 using Nd, Pr, Fe, and FeB as raw materials. From the observation of the structure form of this sample with the method described above, the main phase 10 in which Nd and Pr are provided mixedly is confirmed due to the addition of Pr, but a core-shell structure is not formed. In addition, due to the absence of La and Sm, it is also not confirmed that the concentration of Sm in the subphase 20 is higher in the first subphase 21 than in the second subphase 22. The evaluation of the magnetic properties of this sample with the method described above shows that the residual magnetic flux density is “good” and the coercive force is “poor” because Tb which is the heavy rare earth element RH is not included. In addition, due to the addition of Pr, the temperature coefficient of the coercive force is “poor”. Since the production method does not include hot working, the magnetizing ability is “equivalent or better”. Note that the temperature coefficient of the residual magnetic flux density is “equivalent”. This result reflects the fact that the magnetic anisotropy of the main phase 10 is increased and the coercive force is improved by the addition of Pr, but the structure form is not optimal in the main phase 10 and the subphase 20.

Comparative Example 4 is a sample of the rare earth sintered magnet 1 prepared in the form of (Nd, Pr, Tb)—Fe—B with the production method described in Patent Literature 1 using Nd, Pr, Tb, Fe, and FeB as raw materials. From the observation of the structure form of this sample with the method described above, the main phase 10 in which Nd and Pr are provided mixedly is confirmed, but a core-shell structure is not formed. In addition, due to the absence of La and Sm, it is also not confirmed that the concentration of Sm in the subphase 20 is higher in the first subphase 21 than in the second subphase 22. The evaluation of the magnetic properties of this sample with the method described above shows that the residual magnetic flux density is “equivalent” because the addition of Tb which is the heavy rare earth element RH is equivalent to that in Comparative Example 1. Due to the addition of Pr in addition to the addition of Tb which is the heavy rare earth element RH, the coercive force is “good”, and the temperature coefficient of the coercive force is “poor”. Since the production method does not include hot working, the magnetizing ability is “equivalent or better”. Note that the temperature coefficient of the residual magnetic flux density is “equivalent”. This result reflects the fact that the magnetic anisotropy of the main phase 10 is increased and the coercive force is improved by the addition of Tb and Pr, but the structure form is not optimal in the main phase 10 and the subphase 20.

Comparative Example 5 is a sample of the rare earth sintered magnet 1 prepared in the form of (Nd, La, Sm)—Fe—B with the production method described in Patent Literature 1 using Nd, La, Sm, Fe, and FeB as raw materials. From the observation of the structure form of this sample with the method described above, no core-shell structure is confirmed in the main phase 10 due to the absence of Pr. In addition, due to the addition of La and Sm, the concentration of Sm is segregated in one subphase 20 along with the segregation of La, but the second subphase 22 does not exist. Furthermore, it is also not confirmed that the concentration of Sm is higher in the first subphase 21 than in the second subphase 22. The evaluation of the magnetic properties of this sample with the method described above shows that the residual magnetic flux density is “good” and the coercive force is “poor” because Tb which is the heavy rare earth element RH is not included. In addition, due to the addition of La and Sm, the temperature coefficient of the coercive force is “good”. Since the production method does not include hot working, the magnetizing ability is “equivalent or better”. In addition, the temperature coefficient of the residual magnetic flux density is “equivalent”. This result reflects the fact that the presence of La and Sm in the main phase 10 or the subphase 20 gives a good result in the temperature coefficient of the coercive force, but the magnetic properties at room temperature are not improved, and the structure form is not optimal in the main phase 10 and the subphase 20.

Comparative Example 6 is a sample of the rare earth sintered magnet 1 prepared in the form of (Nd, La, Sm)—Fe—B with the production method described in Patent Literature 1 using Nd, La, Sm, Fe, and FeB as raw materials. The composition ratio of Nd, La, and Sm is different from that of Comparative Example 5. From the observation of the structure form of this sample with the method described above, no core-shell structure is confirmed in the main phase 10 due to the absence of Pr. In addition, due to the addition of La and Sm, the concentration of Sm is segregated in one subphase 20 along with the segregation of La, but the second subphase 22 does not exist. Furthermore, it is also not confirmed that the concentration of Sm is higher in the first subphase 21 than in the second subphase 22. The evaluation of the magnetic properties of this sample with the method described above shows that the residual magnetic flux density is “good” and the coercive force is “poor” because Tb which is the heavy rare earth element RH is not included. Due to the optimization of the addition amounts of La and Sm, the temperature coefficient of the residual magnetic flux density is “good”, and the temperature coefficient of the coercive force is “good”. Since the production method does not include hot working, the magnetizing ability is “equivalent or better”. The result of Comparative Example 6 reflects the fact that the optimization of the addition amounts of La and Sm gives a good result in the temperature coefficient of the magnetic properties, but the magnetic properties at room temperature are not improved because Tb which is the heavy rare earth element RH is not added to the base material, and the structure form is not optimal in the main phase 10 and the subphase 20. The change in the composition ratio of Nd, La, Sm results in almost the same result as in Comparative Example 5.

Comparative Example 7 is a sample of the rare earth sintered magnet 1 prepared in the form of (Nd, Pr, La, Sm)—Fe—B with the production method described in Patent Literature 1 using Nd, Pr, La, Sm, Fe, and FeB as raw materials. From the observation of the structure form of this sample with the method described above, the main phase in which Nd and Pr are provided mixedly is confirmed due to the addition of Pr, but a core-shell structure is not formed. In addition, due to the addition of La and Sm, the concentration of Sm is segregated in one subphase 20 along with the segregation of La, but the second subphase 22 does not exist. Furthermore, it is also not confirmed that the concentration of Sm is higher in the first subphase 21 than in the second subphase 22. The evaluation of the magnetic properties of this sample with the method described above shows that the residual magnetic flux density is “good” and the coercive force is “poor” because Tb which is the heavy rare earth element RH is not included. Although the temperature coefficient of the residual magnetic flux density and the temperature coefficient of the coercive force should be “good” by the optimization of the addition amounts of La and Sm, only the temperature coefficient of the coercive force is decreased to “equivalent” by the addition of Pr. Since the production method does not include hot working, the magnetizing ability is “equivalent or better”.

Comparative Example 8 is a sample of the rare earth sintered magnet 1 prepared in the form of (Nd,Tb)—Fe—B with the production method including hot working described in Patent Literature 2 using Nd,Tb, Fe, and FeB as raw materials. From the observation of the structure form of this sample with the method described above, due to the absence of Pr, La, and Sm, no core-shell structure is confirmed in the main phase 10, and it is not confirmed that the concentration of Sm in the subphase 20 is higher in the first subphase 21 than in the second subphase 22. However, the refinement of the structure, which is a characteristic of a magnet produced with hot working, is confirmed. The evaluation of the magnetic properties of this sample with the method described above shows that the coercive force is “good” and the temperature coefficient of coercive force is “equivalent” due to the refinement of the magnetic powder. In addition, since the magnetic moments are less likely to be aligned, the residual magnetic flux density and the magnetizing ability are “poor”. The temperature coefficient of the residual magnetic flux density is “equivalent”. This result reflects the decrease in residual magnetic flux density and deterioration in magnetizing ability because the magnetic moments are less likely to be aligned, despite the improvement of the absolute value of the coercive force and the temperature coefficient of the coercive force associated with the refinement of the magnetic powder through hot working.

Comparative Example 9 is a sample of the rare earth sintered magnet 1 prepared in the form of Nd—Fe—B with the production method including hot working described in Patent Literature 2 using Nd, Fe, and FeB as raw materials. From the observation of the structure form of this sample with the method described above, due to the absence of Pr, La, and Sm, no core-shell structure is confirmed in the main phase 10, and it is not confirmed that the concentration of Sm in the subphase 20 is higher in the first subphase 21 than in the second subphase 22. However, the refinement of the structure, which is a characteristic of a magnet produced with hot working, is confirmed. The evaluation of the magnetic properties of this sample with the method described above shows that the coercive force is “good” and the temperature coefficient of coercive force is “equivalent” due to the refinement of the magnetic powder. In addition, since the magnetic moments are less likely to be aligned, the residual magnetic flux density and the magnetizing ability are “poor”. The temperature coefficient of the residual magnetic flux density is “equivalent”. This result reflects the decrease in residual magnetic flux density and deterioration in magnetizing ability because the magnetic moments are less likely to be aligned, despite the improvement of the coercive force associated with the refinement of the magnetic powder through hot working.

Comparative Example 10 is a sample of the rare earth sintered magnet 1 prepared in the form of (Nd, Pr)—Fe—B with the production method including hot working described in Patent Literature 2 using Nd, Pr, Fe, and FeB as raw materials. From the observation of the structure form of this sample with the method described above, the core-shell structure is confirmed through hot working in addition to the addition of Pr, the core-shell structure is confirmed only in one type of main phase 10 having a high Pr concentration in the core portion. In addition, due to the absence of La and Sm, it is also not confirmed that the concentration of Sm in the subphase 20 is higher in the first subphase 21 than in the second subphase 22. The evaluation of the magnetic properties of this sample with the method described above shows that the coercive force is “good” and the temperature coefficient of coercive force is “equivalent” due to the refinement of the magnetic powder. In addition, since the magnetic moments are less likely to be aligned, the residual magnetic flux density and the magnetizing ability are “poor”. The temperature coefficient of the residual magnetic flux density is “equivalent”. This indicates that the coercive force is significantly improved to the level of the rare earth sintered magnet 1 containing Tb due to the formation of the core-shell structure having a high Pr concentration in the core portion, but the other properties reflect the structure refinement due to hot working.

Comparative Example 11 is a sample of the rare earth sintered magnet 1 prepared in the form of (Nd, Pr, Tb)—Fe—B with the production method including hot working described in Patent Literature 2 using Nd, Pr, Tb, Fe, and FeB as raw materials. From the observation of the structure form of this sample with the method described above, the core-shell structure is confirmed through hot working in addition to the addition of Pr, the core-shell structure is confirmed only in one type of main phase 10 having a high Pr concentration in the core portion. In addition, due to the absence of La and Sm, it is also not confirmed that the concentration of Sm in the subphase 20 is higher in the first subphase 21 than in the second subphase 22. In addition, the evaluation of the magnetic properties of this sample with the method described above shows that the coercive force is “good” and the temperature coefficient of coercive force is “equivalent” due to the refinement of the magnetic powder. In addition, since the magnetic moments are less likely to be aligned, the residual magnetic flux density and the magnetizing ability are “poor”. The temperature coefficient of the residual magnetic flux density is “equivalent”. This indicates that the coercive force is significantly improved by the substitution of Tb having high magnetocrystalline anisotropy for a part of Nd in addition to the manufacture with hot working, but the other properties reflect the refinement of the structure through hot working.

Comparative Example 12 is a sample of the rare earth sintered magnet 1 prepared in the form of (Nd, La, Sm)—Fe—B with the production method including hot working described in Patent Literature 2 using Nd, La, Sm, Fe, and FeB as raw materials. From the observation of the structure form of this sample with the method described above, no core-shell structure is confirmed in the main phase 10 due to the absence of Pr. In addition, due to the addition of La and Sm, the concentration of Sm is segregated in one subphase 20 along with the segregation of La, but the second subphase 22 does not exist.

Furthermore, it is also not confirmed that the concentration of Sm is higher in the first subphase 21 than in the second subphase 22. In addition, the evaluation of the magnetic properties of this sample with the method described above shows that the coercive force and the temperature coefficient of coercive force are “good” due to the refinement of the magnetic powder. In addition, since the magnetic moments are less likely to be aligned, the residual magnetic flux density and the magnetizing ability are “poor”. The temperature coefficient of the residual magnetic flux density is “good”. This result reflects the fact that the presence of La and Sm in the main phase 10 or the subphase 20 gives a good result in the temperature coefficient of the magnetic properties, but the residual magnetic flux density and the magnetizing ability at room temperature are not improved since the magnetic moments are less likely to be aligned, and the structure form is not optimal in the main phase 10 and the subphase 20.

Comparative Example 13 is a sample of the rare earth sintered magnet 1 prepared in the form of (Nd, La, Sm)—Fe—B with the production method including hot working described in Patent Literature 2 using Nd, La, Sm, Fe, and FeB as raw materials. The composition ratio of Nd, La, and Sm is different from that of Comparative Example 12. From the observation of the structure form of this sample with the method described above, no core-shell structure is confirmed in the main phase 10 due to the absence of Pr. In addition, due to the addition of La and Sm, the concentration of Sm is segregated in one subphase 20 along with the segregation of La, but the second subphase 22 does not exist. Furthermore, it is also not confirmed that the concentration of Sm is higher in the first subphase 21 than in the second subphase 22. In addition, the evaluation of the magnetic properties of this sample with the method described above shows that the coercive force and the temperature coefficient of coercive force are “good” due to the refinement of the magnetic powder. In addition, since the magnetic moments are less likely to be aligned, the residual magnetic flux density and the magnetizing ability are “poor”. The temperature coefficient of the residual magnetic flux density is “good”. This result reflects the fact that the presence of La and Sm in the main phase 10 or the subphase 20 gives a good result in the temperature coefficient of the magnetic properties, but the residual magnetic flux density and the magnetizing ability at room temperature are not improved since the magnetic moments are less likely to be aligned, and the structure form is not optimal in the main phase 10 and the subphase 20. The change in the composition ratio of Nd, La, Sm results in almost the same result as in Comparative Example 12.

Comparative Example 14 is a sample of the rare earth sintered magnet 1 prepared in the form of (Nd, Pr, La, Sm)—Fe—B with the production method including hot working described in Patent Literature 2 using Nd, Pr, La, Sm, Fe, and FeB as raw materials. From the observation of the structure form of this sample with the method described above, the core-shell structure is confirmed through hot working in addition to the addition of Pr, the core-shell structure is confirmed only in one type of main phase 10 having a high Pr concentration in the core portion. In addition, due to the addition of La and Sm, the concentration of Sm is segregated in one subphase 20 along with the segregation of La, but the second subphase 22 does not exist. Furthermore, it is also not confirmed that the concentration of Sm is higher in the first subphase 21 than in the second subphase 22. In addition, the evaluation of the magnetic properties of this sample with the method described above shows that the coercive force and the temperature coefficient of coercive force are “good” due to the refinement of the magnetic powder. In addition, since the magnetic moments are less likely to be aligned, the residual magnetic flux density and the magnetizing ability are “poor”. The temperature coefficient of the residual magnetic flux density is “good”. This indicates that the coercive force is significantly improved to the level of the rare earth sintered magnet 1 containing Tb due to the formation of the core-shell structure having a high Pr concentration in the core portion, and the presence of La and Sm in the main phase 10 or the subphase 20 improves the temperature coefficient of the magnetic properties, particularly the temperature coefficient of the coercive force. However, the result also reflects the fact that the residual magnetic flux density and the magnetizing ability at room temperature are not improved since the magnetic moments are less likely to be aligned, and the structure form is not optimal in the main phase 10 and the subphase 20.

The samples of Examples 1 to 8 are the rare earth sintered magnet 1 including the main phase 10 that satisfies a general formula (Nd, Pr, Tb, R)—Fe—B, where the heavy rare earth element RH is Tb, and R is one or more rare earth elements selected excluding Nd, Pr, and Tb, the main phase 10 containing crystal grains based on an Nd₂Fe₁₄B crystal structure, wherein the main phase 10 includes the core portions 11c and 12c and the shell portions 11s and 12s covering the core portions 11c and 12c, the main phase 10 mixedly includes the first main phase 11 that satisfies CNd>CPr and the second main phase 12 that satisfies CNd<CPr, and the concentration of Tb which is the heavy rare earth element RH in the core portion 11c of the first main phase 11 is higher than the concentration of Tb in the core portion 12c of the second main phase 12. The rare earth sintered magnet 1 of Examples 1 to 8 is based on R=La and/or Sm, the first subphase 21 that is crystalline and has a main component based on an oxide phase represented by (Nd, Pr, Tb, La, Sm)—O, and the second subphase 22 that is crystalline and has a main component represented by (Nd, Pr, Tb, La)—O are included, in addition to the first main phase 11 and the second main phase 12, the concentration of Sm is higher in the first subphase 21 than in the second subphase 22, and the Sm enrichment portion 41 is formed in the first subphase 21. The evaluation of the magnetic properties of the samples according to Examples 1 to 8 with the method described above shows that the residual magnetic flux density is “good”, the coercive force is “good”, the temperature coefficient of residual magnetic flux density is “good”, the temperature coefficient of coercive force is “good”, and the magnetizing ability is “equivalent or better”. As a result, these rare earth sintered magnets 1 achieve the effect of having excellent magnetic properties and magnetization as compared with the related art, while reducing use of Nd and the heavy rare earth element RH that are expensive and have a procurement risk due to high distribution unevenness.

In addition, as can be seen from Table 3, in the samples of Examples 1 to 8, the content of Tb, which is the heavy rare earth element RH, is smaller than that in the samples of Comparative Examples 1, 4, 8, and 11, but results superior in magnetic properties, as compared with those of the samples of Comparative Examples 1 to 14 are obtained. In particular, when trying to obtain magnetic properties equivalent to those of the samples of Examples 1 to 8 in the samples of Comparative Examples 8 and 11 produced with the production method of Patent Literature 2, it is necessary to further contain Tb. Thus, the rare earth sintered magnet 1 according to the first and second embodiments also has an effect of reducing the amount of the heavy rare earth element RH used as compared with the technique of Patent Literature 2. Alternatively, in a case where the content of the heavy rare earth element RH in the rare earth magnet produced with the production method in Patent Literature 2 is the same as the content of the heavy rare earth element RH in the rare earth sintered magnet 1 according to the first and second embodiments, the magnetic properties of the rare earth magnet produced with the production method in Patent Literature 2 are lower than the magnetic properties of the rare earth sintered magnet 1 according to the first and second embodiments. In addition, Table 3 shows that, as compared with the samples of Comparative Examples 1 and 4 produced with the production method in Patent Literature 1, the samples of Examples 1 to 8 can improve magnetic properties while reducing the content of Tb, which is the heavy rare earth element RH.

The configurations described in the above-mentioned embodiments indicate examples. The embodiments can be combined with another well-known technique and with each other, and some of the configurations can be omitted or changed in a range not departing from the gist.

### REFERENCE SIGNS LIST

1 rare earth sintered magnet; 10 main phase; 11 first main phase; 11c, 12c core portion; 11s, 12s shell portion; 12 second main phase; 20 subphase; 21 first subphase; 22 second subphase; 41 Sm enrichment portion; 42 heavy rare earth element containing portion; 100 rotor; 101 rotor core; 102 magnet insertion hole; 120 rotary machine; 130 stator; 131 teeth; 132 winding.

1. A rare earth sintered magnet comprising:
a main phase that satisfies a general formula (Nd, Pr, RH, R)—Fe—B, where RH is a heavy rare earth element including at least one of Dy or Tb, R is one or more rare earth elements selected excluding Nd, Pr, Dy, and Tb, the main phase containing crystal grains based on an Nd₂Fe₁₄B crystal structure, wherein
the main phase includes a core portion and a shell portion covering the core portion,
the main phase includes a first main phase that satisfies CNd>CPr and a second main phase that satisfies CNd<CPr, where CNd is concentration of Nd in the core portion and CPr is concentration of Pr in the core portion,
concentration of the heavy rare earth element RH in the core portion of the first main phase is higher than concentration of the heavy rare earth element RH in the core portion of the second main phase, and
the first main phase and the second main phase are provided mixedly.

2. The rare earth sintered magnet according to claim 1, wherein number of the first main phases is larger than number of the second main phases.

3. The rare earth sintered magnet according to claim 1, wherein
the first main phase satisfies relational expressions of CNd>SNd, CPr<SPr, and CRH>SRH, and the second main phase satisfies relational expressions of CNd<SNd, CPr>SPr, and CRH<SRH, where SNd is concentration of Nd in the shell portion, SPr is concentration of Pr in the shell portion, CRH is concentration of the heavy rare earth element RH in the core portion of the main phase, and SRH is concentration of the heavy rare earth element RH in the shell portion.

4. The rare earth sintered magnet according to claim 1, wherein
given that R is La and/or Sm, the rare earth sintered magnet further comprises a first subphase that is crystalline and has a main component based on an oxide phase represented by (Nd, Pr, RH, La, Sm)—O, and a second subphase that is crystalline and has a main component represented by (Nd, Pr, RH, La)—O, and
the first subphase forms an Sm enrichment portion having a higher concentration of Sm than the second subphase.

5. A method for producing the rare earth sintered magnet according to claim 1, the method comprising:
melting a raw material of a rare earth sintered magnet alloy containing an element constituting the rare earth sintered magnet;
cooling the raw material molten to obtain a solidified alloy;
further cooling the solidified alloy to obtain a rare earth sintered magnet alloy;
pulverizing the rare earth sintered magnet alloy satisfying (Nd, Pr, RH, R)—Fe—B;
preparing a molded body by molding powder of the rare earth sintered magnet alloy pulverized;
obtaining a sintered body by sintering the molded body at a sintering temperature that is a predetermined temperature;
holding the sintered body at a primary aging temperature that is a temperature lower than the sintering temperature;
holding the sintered body, which has held at the primary aging temperature, at a secondary aging temperature that is a temperature lower than the primary aging temperature;
holding the sintered body, which has held at the secondary aging temperature, again at the primary aging temperature;
holding the sintered body, which has held again at the primary aging temperature, again at the secondary aging temperature; and
cooling the sintered body, which has held again at the secondary aging temperature.

6. A rotor comprising:
a rotor core; and
the rare earth sintered magnet according to claim 1 provided in the rotor core.

7. A rotary machine comprising:
the rotor according to claim 6; and
an annular stator facing the rotor and including, on an inner surface on a side where the rotor is placed, windings provided on teeth protruding toward the rotor.

8. A method for producing the rare earth sintered magnet according to claim 2, the method comprising:
melting a raw material of a rare earth sintered magnet alloy containing an element constituting the rare earth sintered magnet;
cooling the raw material molten to obtain a solidified alloy;
further cooling the solidified alloy to obtain a rare earth sintered magnet alloy;
pulverizing the rare earth sintered magnet alloy satisfying (Nd, Pr, RH, R)—Fe—B;
preparing a molded body by molding powder of the rare earth sintered magnet alloy pulverized;
obtaining a sintered body by sintering the molded body at a sintering temperature that is a predetermined temperature;
holding the sintered body at a primary aging temperature that is a temperature lower than the sintering temperature;
holding the sintered body, which has held at the primary aging temperature, at a secondary aging temperature that is a temperature lower than the primary aging temperature;
holding the sintered body, which has held at the secondary aging temperature, again at the primary aging temperature;
holding the sintered body, which has held again at the primary aging temperature, again at the secondary aging temperature; and
cooling the sintered body, which has held again at the secondary aging temperature.

9. A method for producing the rare earth sintered magnet according to claim 3, the method comprising:
melting a raw material of a rare earth sintered magnet alloy containing an element constituting the rare earth sintered magnet;
cooling the raw material molten to obtain a solidified alloy;
further cooling the solidified alloy to obtain a rare earth sintered magnet alloy;
pulverizing the rare earth sintered magnet alloy satisfying (Nd, Pr, RH, R)—Fe—B;
preparing a molded body by molding powder of the rare earth sintered magnet alloy pulverized;
obtaining a sintered body by sintering the molded body at a sintering temperature that is a predetermined temperature;
holding the sintered body at a primary aging temperature that is a temperature lower than the sintering temperature;
holding the sintered body, which has held at the primary aging temperature, at a secondary aging temperature that is a temperature lower than the primary aging temperature;
holding the sintered body, which has held at the secondary aging temperature, again at the primary aging temperature;
holding the sintered body, which has held again at the primary aging temperature, again at the secondary aging temperature; and
cooling the sintered body, which has held again at the secondary aging temperature.

10. A method for producing the rare earth sintered magnet according to claim 4, the method comprising:
melting a raw material of a rare earth sintered magnet alloy containing an element constituting the rare earth sintered magnet;
cooling the raw material molten to obtain a solidified alloy;
further cooling the solidified alloy to obtain a rare earth sintered magnet alloy;
pulverizing the rare earth sintered magnet alloy satisfying (Nd, Pr, RH, R)—Fe—B;
preparing a molded body by molding powder of the rare earth sintered magnet alloy pulverized;
obtaining a sintered body by sintering the molded body at a sintering temperature that is a predetermined temperature;
holding the sintered body at a primary aging temperature that is a temperature lower than the sintering temperature;
holding the sintered body, which has held at the primary aging temperature, at a secondary aging temperature that is a temperature lower than the primary aging temperature;
holding the sintered body, which has held at the secondary aging temperature, again at the primary aging temperature;
holding the sintered body, which has held again at the primary aging temperature, again at the secondary aging temperature; and
cooling the sintered body, which has held again at the secondary aging temperature.

11. A rotor comprising:
a rotor core; and
the rare earth sintered magnet according to claim 2 provided in the rotor core.

12. A rotor comprising:
a rotor core; and
the rare earth sintered magnet according to claim 3 provided in the rotor core.

13. A rotor comprising:
a rotor core; and
the rare earth sintered magnet according to claim 4 provided in the rotor core.

14. A rotary machine comprising:
the rotor according to claim 11; and
an annular stator facing the rotor and including, on an inner surface on a side where the rotor is placed, windings provided on teeth protruding toward the rotor.

15. A rotary machine comprising:
the rotor according to claim 12; and
an annular stator facing the rotor and including, on an inner surface on a side where the rotor is placed, windings provided on teeth protruding toward the rotor.

16. A rotary machine comprising:
the rotor according to claim 13; and
an annular stator facing the rotor and including, on an inner surface on a side where the rotor is placed, windings provided on teeth protruding toward the rotor.
